(19) United States
(12) Patent Application Publication
(10) Pub. No.: US 2006/0200798 A1
(43) Pub. Date: Sep. 7, 2006

(54) Applications of discrete and geometric calculus

(75) Inventor: Virginia Ceceile Harrison, Berkeley, CA (US)

Correspondence Address: MICHAELSON & ASSOCIATES, P.O. BOX 8489, RED BANK, NJ, 07701, US

(73) Assignee: The Regents of the University of California, Oakland, CA (US)

(21) Appl. No.: 11/325,232

(22) Filed: Jan. 3, 2006

Related U.S. Application Data
(60) Provisional application No. 60/641,088, filed on Jan. 3, 2005.

(51) Int. Cl. G06F 9/44

(52) U.S. Cl. 717/108; 717/116

(57) ABSTRACT

An approach to calculus is presented resulting in a coordinate-free theory on manifolds building upon Cartan exterior calculus, which can be viewed as part of the space of polyhedral chains completed with respect to a natural norm as defined herein. The resulting space of “chainlets” provides an improved basis on which to construct discrete approximations to objects for purposes of computer modeling of the objects.

### CROSS REFERENCE TO RELATED APPLICATIONS

This application claims priority from co-pending patent provisional patent application Ser. No. 60/641,088 filed Jan. 3, 2005 pursuant to one or more of 35 U.S.C. § 119, § 120, § 365. The entire contents of the cited provisional patent application is incorporated herein by reference for all purposes.

### BACKGROUND OF THE INVENTION

1. Field of Invention

This invention relates generally to the field of discrete and geometric calculus and, more particularly, to extensions thereof having particular application to problems in the calculus of variations

2. Description of the Invention

### Preface

In these notes we present a new approach to calculus in which more efficient choices of limits are taken at key points of the development. For example, k-dimensional tangent spaces are replaced by representations of simple k-vectors supported in a point as limits of simplicial k-chains in a Banach space (much like Dirac monopoles). This subtle difference has powerful advantages that will be explored. Through these “infinitesimals”, we obtain a coordinate free theory on manifolds that builds upon the Cartan exterior calculus. An infinite array of approximating theories to the calculus of Newton and Lebiniz becomes available and we can now revisit old philosophical questions such as which models are most natural for the continuum or for physics.

Within this new theory of Geometric Calculus are found the classical theory on smooth manifolds, as well as three distinct, new extensions. All three can be seen as part of the space of polyhedral chains completed with respect to what the author calls the “natural norm”. The author calls elements of the Banach space obtained upon completion “chainlets”.

We take many viewpoints in mathematics and its applications, be it smooth manifolds, Lipschitz structures, polyhedra, fractals, finite elements, soap films, measures, numerical methods, etc. The choice sets the stage and determines our audience and our methods. No particular viewpoint is “right” for all applications. The Banach space of chainlets unifies these viewpoints.
1. Discrete Calculus* with convergence to the smooth continnuum, including more general theorems of Stokes, Green and Gauss.
   *Some aspects of this are contained in the paper [10] and slides prepared for the Caltech meeting in October, 2003 on Discrete Geometry for Mechanics are available on line at http://math.berkeley.edu/˜harrison.
2. Bilayer Calculus with applications to the calculus of variations including Plateau's problem (soap bubbles).
3. Calculus on Fractals

The discrete theory is perhaps the most far reaching. Poincaré taught us to use a simplicial complex as the basic discrete model. It has become fashionable to use Whitney forms [2] as cochains and they are based on the simplicial complex. However, there is a great deal information within a simplicial complex that is not needed for calculus. There are corners, matching boundaries of simplices, ratios of length to area, and so forth. The standard proof to Stokes' theorem relies on boundaries matching and cancelling with opposite orientation where they meet. However, problems of approximation sometimes arise in the continuum limit, as a finer and finer mesh size is used. For example,
Supposed approximations may not converge
Vectors, especially normal vectors, may be hard to define
Cochains fail to satisfy a basic property such as commutativity or associativity of wedge product, or existence of Hodge star.

One may discard much of the information in a simplicial complex and instead use sums of what are essentially “weighted oriented monopoles and higher order dipoles” as approximators for both domains and integrands. (These will be fully described in the lectures.) Standard operators such as boundary, coboundary, exterior derivative and Laplace are naturally defined on these “element chains”. Integral relations of calculus are valid and essentially trivial at this discrete level and converge to the continuum limit. Vectors have discrete counterparts, including normal vectors, and discrete cochains are well behaved.

One of our goals in these notes is to write the theorems of Stokes, Gauss and Green in such a concise and clear manner that all manner of domains are permitted without further effort. We obtain this by first treating the integral as a bilinear functional on pairs of integrands and domains, i.e., forms and chainlets. Secondly, we define a geometric Hodge star operator * on domains A and proving for k-forms ω in n-space
∫_{∂A}ω=∫_{A}dω
and
∫_{*A}*ω=∫_{A}ω
with appropriate assumptions on the domain and integrand (see Chapter 4). One may immediately deduce
∫_{*∂A}ω=(−1)^{k(n-k)}∫_{A}d*ω
and
∫_{∂*A}^{ω}=(−1)^{(k+1)(n-k-1)}∫_{A}^{*dω}
which are generalized and optimal versions of the divergence and curl theorems, respectively.

Arising from this theory are new, discrete approximations for the real continuum. Morris Hirsch wrote,^{†} on Dec. 13, 2003.
A basic philosophical problem has been to make sense of “continuum”, as in the space of real numbers, without introducing numbers. Weyl [5] wrote, “The introduction of coordinates as numbers . . . is an act of violence”. Poincaré wrote about the “physical continuum” of our intuition, as opposed to the mathematical continuum. Whitehead (the philosopher) based our use of real numbers on our intuition of time intervals and spatial regions. The Greeks tried, but didn't get very far in doing geometry without real numbers. But no one, least of all the Intuitionists, has come up with even a slightly satisfactory replacement for basing the continuum on the real number system, or basing the real numbers on Dedekind cuts, completion of the rationals, or some equivalent construction.
   ^{†}e-mail message, quoted with permission

Harrison's theory of chainlets can be viewed as a different way to build topology out of numbers. It is a much more sophisticated way, in that it is (being) designed with the knowledge of what we have found to be geometrically useful (Hodge star. Stokes' theorem, all of algebraic topology, . . . ), whereas the standard development is just ad hoc-starting from Greek geometry, through Newton's philosophically incoherent calculus, Descarte's identification of algebra with geometry, with additions of abstract set theory, Cauchy sequences, mathematical logic, categories, topoi, probability theory, and so forth, as needed. We could add quantum mechanics, Feynman diagrams and string theory! The point is this is a very roundabout way of starting from geometry, building all that algebraic machinery, and using it for geometry and physics. I don't think chainlets, or any other purely mathematical theory, will resolve this mess, but it might lead to a huge simplification of important parts of it.

Readers may choose any number of points of view. Smooth manifolds, discrete element chains, polyedra, fractals, any dense set of chainlets will produce the same results in the limit, which links together numerous approaches some of which seemed distantly related, at best. Philosophically, we may not know the most natural models for physics, but we provide here various options which all converge to the continuum limit and are consistent with each other and standard operators of mathematics and physics. We anticipate applications to physics, continuum mechanics, biology, electromagnetism, finite element method, PDE's, dynamics, computation, wavelets, vision modeling as well as to pure mathematics (topology, foundations, geometry, dynamical systems) and give examples in the notes that follow. Indeed, the author proposes that the discrete theory provides a foundation for new models for quantum field theory, a topic under development. Algebraic/geometric features of the models make them especially enticing. It is worse to be oblivious to the importance of a new theory than to be overly excited, and the author chooses to err on the side of the latter.

I am grateful to the Scientific Council of GNFM for inviting me to give this course, and to the Director of the Ravello Summer School, Professor Salvatore Rionero, for his elegant hospitality. I also wish to thank Antonio Di Carlo, Paolo Podio-Guidugli, Gianfranco Capriz and the other participants of the Ravello Summer School for their interest in my work and for encouraging me to put my scribbled lecture notes into their present form. Above all, I thank Morris Hirsch and James Yorke for listening over these years. Their support and encouragement have been critical to the success of this research program.
Harrison, Jenny, Stokes' theorem on nonsmooth chains, Bulletin AMS, October 1993.
-, Continuity of the Integral as a Function of the Domain, Journal of Geometric Analysis, 8 (1998), no. 5, 769-795.
-. Isomorphisms differential forms and cochains, Journal of Geometric Analysis, 8 (1998), no. 5, 797-807.
-, Geometric realizations of currents and distributions, Proceedings of Fractals and Stochastics III, Friedrichsroda, German, 2004.
-, Geometric Hodge star operator with applications to the theorems of Gauss and Green, to appear, Proc Cam Phil Soc.
-, Cartan's Magic Formula and Soap Film structures, Journal of Geometric Analysis
-, On Plateau's Problem with a Bound on Energy, Journal of Geometric Analysis
-, Discrete Exterior Calculus with Convergence to the Smooth Continuum, preprint in preparation
-, Measure and dimension of chainlet domains, preprint in preparation

### Geometric Integration Theory

Geometric Integration Theory (GIT), the great classic of Hassler Whitney [2], was an attempt to articulate the approach to calculus favored by Leibnitz of approximation of domains by polyhedral chains rather than by parametrization by locally smooth coordinate charts. Approximation by polyhedral chains defined using finite sums of cells, simplexes, cubes, etc., has been a technique commonly used by applied mathematicians, engineers, physicists and computer scientists but has not had the benefit of rigorous mathematical support to guarantee convergence. We often create grids around a domain depending on a small scale parameter, perform calculations on each grid, let the parameter tend to zero, and hope the answers converge to something meaningful. Sometimes the limit appears to exist, but actually does not. An example, given by Schwarz, is that of a cylinder with unit area, but approximated by simplicial chains with vertices on the cylinder whose areas limit to any positive number in the extended reals.

Whitney's theory was based on the idea of completing the space of polyhedral chains with a norm and proving continuity of basic operators of calculus with respect to that norm, thereby obtaining a theory of calculus on all points in the Banach space. This approach had worked well for spaces of functions and Whitney was the first to try it out for domains of integration.

Unfortunately, his definitions from the late 1940's brought with them serious technical obstructions that precluded extension of most theorems of calculus. His first norm, the sharp norm, does not have a continuous boundary operator so one cannot state the generalized Stokes' theorem
∫_{∂A}ω=∫_{A}dω
for elements A of the Banach space obtained upon completion. (It is not necessary for the reader to know the definition of the sharp norm as given by Whitney to understand these notes.)

His second norm, the flat norm, has a continuous boundary operator built into it, but does not have a continuous Hodge star operator, and thus one may not state either a generalized divergence or curl theorem in the flat normed space. (See Table 1.) In this introduction, we use terminology such as “flat norm” and “Hodge star operator” that will be defined in later sections.

### Geometric Measure Theory

Geometric measure theory [4], the study of domains through weak convergence and measures, took the approach of using dual spaces of differential forms and had greater success in extending calculus. The extension of the Gauss-Green theorem, credited to de Giorgi and Federer, was a striking application of GMT. Their divergence theorem holds for an n-dimensional current C with Lⁿ Lebesgue measurable support and Hⁿ⁻¹ Hausdorff measurable current boundary. The vector field F is assumed to be Lipschitz. Their conclusion takes the form
∫_{∂C}F(x)·n(C, x)dHⁿ⁻¹x=∫_{C}divF(x)dLⁿx.
The hypotheses imply the existence a.e. of measure theoretic normals n(C, x) to the (“current”) boundary. See [4]

A second crowning achievement of GMT was a solution to the problem of Plateau. Plateau [1] studied soap films experimentally and noticed that soap film surfaces could meet in curves in only two ways: Three films can come together along a curve at equal 120 degree angles, and four such curves can meet at a point at equal angles of about 109 degrees.

The question arose: Given a closed loop of wire, is there a surface with minimal area spanning the curve? Douglas won the first Field's medal for his solution in the class of smooth images of disks. Federer and Fleming were able to provide a solution within the class of embedded, orientable surfaces. They do not model branched surfaces and do not permit the Moebius strip solution as a possible answer, though such solutions do occur in nature.

The most recent area of application of GMT has been with fractals and that has reinervated interest in the theory as it provides rigorous methods for studying integral and measure of nonsmooth domains. It is generally accepted that nonsmooth sets appear commonly in mathematics as well as in the real world. Paths of fractional Brownian motion have become fashionable as models of everyday phenomenon such as stock market models, resulting in a growing demand for results of geometric measure theory.

### Geometric Calculus

In these lectures will be developed a third approach that the author calls “geometric calculus” (GC). The theory of GC begins in Lecture 1 begins with a norm the author calls the “natural norm”^{‡} on the linear space of polyhedral k-chains. In contrast to Whitney's norms the boundary and star operators are bounded. (See Table 1.) It follows that they are bounded on the completion Nₖ^{∞} of this normed space which the author calls the space of “k-chainlets”. Similarly, the integral is bounded on polyhedral k-chains in the natural norm. Lecture 2 presents necessary background on exterior calculus. In Lecture 3 we prove a de Rham theorem for dual spaces of chainlets and differential forms. In Lecture 4 we present calculus on chainlets. For example, proving Stokes' theorem on polyhedral chains or on any other dense set in N^{∞} implies it holds on the entire space. We prove a general

TABLE 1
Bounded operators on norms

| norm | d | ★ | Stokes' theorem | Divergence theorem |
|---|---|---|---|---|
| sharp | no | yes | no | no |
| flat | yes | no | yes | no |
| natural | yes | yes | yes | yes |

divergence theorem for a large class of domains. Thus we, will able to measure flux across surfaces such as the lungs. (There should be broad application in applied mathematics for this result.) The generalized divergence theorem is valid for chainlets of any codimension with boundaries that are not even locally finite or locally Euclidean. There is no assumption on the existence of normal vectors anywhere, or even the existence of measure theoretic normals. Our result applies to all currents satisfying the hypotheses of the result of Federer and de Giorgi.
^{‡}This is a pun on Whitney's musically inspired terms, sharp and flat.

The theory of GC has been equally motivated by both GIT and GMT.

A legitimate question is whether this approach is at least as powerful and far reaching. These lectures will examine the three major applications of GMT mentioned above, and will show in what manner each can be improved and simplified. We give additional applications of discrete, fractal and bilayer calculus that have not been significantly developed in GMT or GIT. That GC is simpler than GMT in both concept and execution is a side benefit. We cannot overemphasize the importance of bringing algebra to the domain of integration, as well as the integrand, making the integral a bilinear pairing on forms and chainlets.

As noted above, any dense subset of chainlets leads to a full theory of calculus in the limit. However, different choices of subsets may present quite different initial results before taking limits in the chainlet space. For example, it is shown in Lecture 5 that smooth differential forms are dense in the space of chainlets, as are smooth submanifolds. Lecture 6 presents a theory of locally compact abelian groups leading to a theory of distributions with the notion of differentiaion. Lecture 7 introduces a dense subset of newly discovered chainlets consisting of finite sums of what the author calls “k-elements”. Each k-element is supported in a single point and makes rigorous the notion of an “infinitesimal” of Newton and Leibnitz. We distinguish two meanings of an “infinitesimal”, although we do not use this term beyond the introduction. One is an “infinitesimal domain”, the other is its dual, an “infinitesimal form”. A k-element is a kind of infinitesimal domain.

Higher order k-elements of order s are also introduced in Lecture 7. A k-element of order zero is the same as a k-element which can be thought of as a geometric analogue of the Dirac delta point or a monopole. In the natural norm Banach space the distance between two monopoles at points p and q is proportional to the distance between p and q. Contrast this with the theory of distributions where metrics are defined weakly. Each k-element of order s is again supported in a point. For s=1 we have a dipole, s=2, a quadrupole, and so forth. The number s corresponds loosely to an s order derivative of a delta function, though of course our elements are delta points, the geometric analogs of delta functions and are defined in arbitrary dimension and codimension. There is no upper bound on s, even in dimension one, although k is bounded by the ambient dimension. Each k-element of order s has a well-defined boundary as a sum of (k−1)-element or order (s+1) and it has a discrete analog of a normal bundle defined via the geometric star operator. It is striking that the divergence theorem can be proved at a single point. The space N^{∞} extends standard geometric structures by adding geometric and algebraic attributes to points. We form our basic “multiorder k-element chains” from the direct sum of spaces of k-element chains of order s. The direct sum is required for the boundary and star operators to be closed. Since such “discrete” chains are dense in the space of chainlets, we may develop a discrete approach to the full calculus. Elements of the dual space to k-element chains converge to smooth differential forms in the limit. With this we are able to define operators on forms as dual to geometrically defined operators on k-elements. The forms, which “measure” cells, become perfectly matched for their job, in a coordinate free fashion. In the full discrete theory we quantize matter and energy with models that make their identification transparent, up to a constant.*
*e=mc²

It is a subtle, but significant difference to begin with k-element chains (GC) rather than polyhedral chains (GIT) or k-vectors (GMT). With our approach, at the starting point of GC, we reveal a common denominator for forms and chains that is the essence of Poincaré duality. We make this precise via an extension of tensor analysis, using what the author calls “multitensors” that are monopoles, dipoles, quadrupoles, etc. It is striking that the subspace of k-element chains is reflexive, although the space of chainlets is not, neither are other subspaces such as differential forms or polyhedral chains. In the application to smooth manifolds, there is no longer reliance on tangent spaces, the hardy tools of mathematics. Instead we use the versatile and rich k-elements which have boundaries defined, where other operators apply and the essence of calculus is found. Linear algebra is valid on k-elements and carries over locally to chainlets, much as it has done for manifolds via tangent spaces. The use of k-elements in place of k-dimensional tangent spaces opens up new vistas well beyond the scope of the integral methods of GIT and that is why we prefer to call it GC. New fields of enquiry emerge which will be highlighted as the lectures develop.

Outline
1. Chainlets
2. Exterior algebra
3. Differential forms and cochains (de Rham theorem)
4. Calculus on fractals—star operator (no assumptions of self similarity, connectivity, local Euclidean, or locally finite mass. Chainlets are useful for modeling structures in the physical sciences with nontrivial local structures.)
5. Poincaré duality for chains and cochainlets (chainlet representations of differential forms, cap product, wedge product, convolution product)
6. Locally compact abelian groups
7. Discrete calculus (part I) (a coordinate free approach that contains calculus on smooth manifolds, numerical methods, and more) The first half of this chapter appears in the first part of these lecture notes presented below. The second half, as well as the following chapters, will appear in the second part to follow.
8. Bilayer calculus (soap film structures, calculus of variations on soap films, Lipid bilayers, immiscible fluids, fractures, multilayer calculus, bilayer foliations, Frobenius theorem, differential equations)
9. Measure theory (lower semi continuity of s-mass, k-vector valued additive set functions, s-normable chainlets)
10. Applications

Because these notes are only meant as an introduction to the theory, a number of important results, of necessity, have been left out.

### CHAPTER 1

### Chainlets

### Polyhedral Chains

A cell σ in Rⁿ is the nonempty intersection of finitely many closed affine half spaces. The dimension of σ is k if k is the dimension of the smallest affine subspace E containing σ. The support sptσ of σ is the set of all points in the intersection of half spaces that determine σ.

Assume k>0. An orientation of E is an equivalence class of ordered bases for the linear subspace parallel to E where two bases are equivalent if and only if their transformation matrix has positive determinant. An orientation of σ is defined to be an orientation of its subspace E. Henceforth, all k-cells are assumed to be oriented. (No orientation need be assigned to 0-cells which turn out to be single points {x} in [symbol] ⁿ.) When σ is a simplex, each orientation determines an equivalence class of orderings of the set of vertices of σ.

An algebraic k-chain is a (formal) linear combination of oriented k-cells with coefficients in G= [symbol] or [symbol] The vector space of algebraic k-chains is the quotient of the vector space generated by oriented k-cells by the subspace generated by chains of the form σ+σ′ where σ′ is obtained from σ by reversing its orientation.

Let P=Σαᵢσᵢ be an algebraic k-chain. Following Whitney [2] define the function P(x):=Σαᵢ where the sum is taken over all i such that x ε sptσᵢ. Set P(x):=0 if x is not in the support of any σᵢ. We say that algebraic k-chains P and Q are equivalent and write P˜Q iff the functions P(x) and Q(x) are equal except in a finite set of cells of dimension <k. For example, (−1, 1)˜(−1,0)+(0, 1). A polyhedral k-chain is defined as an equivalence class of algebraic k-chains. This clever definition implies that if P′ is a subdivision of the algebraic chain P, then P and P′ determine the same polyhedral chain which behaves nicely for integrating forms. In particular, algebraic k-chains P and Q are equivalent iff integrals of smooth differential k-forms agree over them. This property is sometimes taken as the definition of a polyhedral chain, but we wish to define it without reference to differential forms. If P is an algebraic chain [P] denotes the polyhedral chain of P. As an abuse of notation we usually omit the square brackets and write P instead of [P]. Denote the linear space of polyhedral chains by Pₖ.

Remarks. Every polyhedral chain P has a nonoverlapping representative. Two cells that have the same coefficient, but opposite orientation will cancel each other where they overlap. If they have the same orientation, their coefficients are added.

The standard boundary operator ∂ on k-cells σ produces an algebraic (k−1)-chain. This extends linearly to a boundary operator on algebraic k-chains. This, in turn, leads naturally to a well defined boundary operator ∂ on polyhedral k-chains for k≧1. For k=0 we set ∂P:=0.

$${P}_{n} {\to }^{\partial } {P}_{n - 1} {\to }^{\partial } ⋯ {\to }^{\partial } {P}_{1} {\to }^{\partial } {P}_{0}$$

is a chain complex since ∂∘∂=0. (We omit the proof which is standard.)

Mass of polyhedral chains.
Let M(σ) denote k-dimensional Lebesgue measure, or k-volume of a k-cell σ. Every 0-cell σ⁰ takes the form σ⁰={x} and we set M(σ⁰)=1. The mass of P is defined by

$$M ( P ) := {\sum }_{i = 1}^{m} \vert {a}_{i} \vert M ( {σ}_{i} )$$

where

$$P = {\sum }_{i = 1}^{m} {a}_{i} {σ}_{i}$$

and the cells σᵢ are non-overlapping. We think of mass as weighted k-volume. For example, the mass of a piecewise linear curve with multiplicity two is twice its arc length. Mass is a norm on the vector space Pₖ. Suppose

$${\sum }_{i = 1}^{m} {a}_{i} {σ}_{i}$$

is a non-overlapping representative of P. The support of P is defined as spt(P):=∪spt(σᵢ).

It is worth noting to those well versed in analysis based on unions and intersections of sets that these definitions are substantially different and bring algebra of multiplicity and orientation into the mathematics at an early stage.

The norms are initially defined for polyhedral k-chains in Euclidean space Rⁿ and it is shown later how to extend the results to singular k-chains in Riemannian manifolds Mⁿ.

Difference cells. For υε [symbol] ⁿ let |υ| denote its norm and T_{υ} translation through υ. Let σ⁰ be a k-cell in [symbol] ⁿ. For consistency of terminology we also call σ⁰ a 0-difference k-cell. Let υ₁ ε [symbol] ⁿ. Define the 1-difference k-cell
σ¹:=σ⁰−T_{υ1}_{₁}σ⁰.
This is a chain consisting of two cells, oppositely oriented. A simple example consists of the sum of the opposite faces of a cube, oppositely oriented. The chain is supported in these two faces. Since it is not always true that T_{υ}σ+T_{ω}σ=T_{υ+ω}σ one has to take care with adding two multicells: σ−T_{υ}σ+σ−T_{ω}σ≠2σ−T_{υ+ω}σ. Given σ⁰ and υ₁, . . . υᵣ ε [symbol] ⁿ, define the j-difference k-cell inductively
σ^{j+1}:=σ^{j}−T_{υ}_{ⱼ₊₁}σ^{j}.
The integer k is the dimension of the multicell, j is its order. *
*This terminology is distinguished from the j-differential k-cells and j-differential k-chainlets that we will define later which are geometric directional derivatives, and thus come from infinitesimal translations.

A j-difference k-cellular chain D^{j} in [symbol] ⁿ is a (formal) sum of j-difference k-cells,

$${D}^{j} = {\sum }_{i = 1}^{m} {a}_{i} {σ}_{i}^{j}$$

with coefficients αᵢεG. The vector space Dₖ^{j} of j-difference k-cellular chains is the quotient of the vector space generated by j-difference k-cells by the subspace generated by multicellular chains of the form (σ−T_{υ}σ)+(σ′−T_{υ}σ′) where σ′ is obtained from σ by reversing its orientation.

Difference norms. Given a j-difference k-cell σ^{j} in [symbol] ⁿ generated by a k-cell σ⁰ and vectors υ₁, . . . , υⱼ, define ∥σ⁰∥₀:=M(σ⁰) and for j≧1
∥σ^{j}∥ⱼ:=M(σ⁰)|υ₁||υ₂| . . . |υⱼ|.
For

$${D}^{j} = {\sum }_{i = 1}^{m} {a}_{i} {σ}_{i}^{j} ,$$

possibly overlapping, define its difference norm as

$${‖ {D}^{j} ‖}_{j} := {\sum }_{i = 1}^{m} \vert {a}_{i} \vert {‖ {σ}_{i}^{j} ‖}_{j} .$$

r-natural norms. Let P ε Pₖ be a polyhedral k-chain. For r=0 define
|P|^{♮0}:=M(P).
For r≧1 define the r-natural norm

$${\vert P \vert}^{{♮}_{r}} := inf \{ {\sum }_{j = 0}^{r} {‖ {D}^{j} ‖}_{j} + {\vert C \vert}^{{♮}_{r - 1}} \}$$

where the infimum is taken over all decompositions

$$P = {\sum }_{j = 0}^{r} {D}^{j} + \partial C$$

where D^{j} ε Pₖ^{j} and C ε Pₖ₊₁. There is at least one decomposition, a trivial one, where D⁰=P and where C and the other D^{j} are zero chains. It is clear | |^{♮r} is a semi-norm. We prove it is a norm in Chapter 3. This norm is often quite difficult to compute. We are more interested in which sequences are Cauchy sequences in this norm.

It follows immediately from the definitions that the boundary operator on chains is bounded w.r.t. the r-natural norms.

PROPOSITION 1.1. If P ε Pₖ then
|∂P|^{♮r}≦|P|^{♮r-1}.
Exercise 1 Find a Cauchy sequence of polyhedral chains in the 1-natural norm that converges pointwise to the graph of the Weierstrass nowhere differentiable function y=Σ2^{-k} sin(2^{3k}x).
Exercise 2 In the plane, define a sequence of polyhedral chains Pₖ as follows: Let σₖ denote the positively oriented square centered at the origin with edge 2^{-k}. Let Pₖ=2^{2k}σₖ. Prove that the Pₖ form a Cauchy sequence in the 1-natural norm. The boundaries ∂Pₖ form a Cauchy sequence in the 2-natural norm.

### CHAPTER 2

### Exterior Algebra

### k-Vectors

The idea of a vector in [symbol] ⁿ as an arrow with length and direction extends to higher dimensions. For 0≦k≦n, we may think of a “simple k-vector” in [symbol] ⁿ much like a small parallelopiped, with well defined k-volume, contained in a k-dimensional subspace of [symbol] ⁿ, called a “k-direction”. We present two approaches for making this precise. The first is well established and comes from the exterior calculus of Cartan. See [11], for example. The second approach will be presented in Chapter 7.

Let [symbol] denote the field of reals with elements denoted a, b, c . . . and V an n-dimensional vector space over [symbol] with elements denoted α, β, γ, . . . For each k=0, 1, 2, . . . , we construct a new vector space
Λ^{k}V
over R called the space of k-vectors in V. By definition
Λ⁰V:= [symbol]
Λ¹V:=V.

The space Λ²V of 2-vectors of V consists of all formal sums
Σαᵢ(αᵢΛβᵢ)
modulo the subspace generated by relations
(αα)Λβ=α(αΛβ)=αΛ(αβ),
(α₁+α₂)Λβ=(α₁Λβ)+(α₂Λβ),
and
αΛβ=−βΛα.
In particular, αΛα=0. We call αΛβ, the exterior product of α and β. A simple 2-vector is a 2-vector that can be written as αΛβ.
Exercise: α and β are dependent iff αΛβ=0.
Exercise: Suppose σ¹, . . . , σⁿ is a basis of V. Prove that σⁱΛσ^{j}, i<j, forms a basis of Λ²V. Hence

$$dim {Λ}^{2} V = ( \begin{matrix}n \\ 2\end{matrix} )$$

(See [11], for example, for details) The space Λ^{k}(V) of k-vectors of V, 2<k≦n, is defined recursively. A k-vector is a formal sum
ΣαᵢαᵢΛβᵢ
where αᵢ εΛ^{k-1}(V) is a simple (k−1)-vector and βᵢ εV, subject to the constraints
(αα)Λβ=α(αΛβ)=αΛ(αβ),
(α₁+α₂)Λβ=(α₁Λβ)+(α₂Λβ),
and
αΛβ=(−1)^{k-1}βΛα.

We set Λ^{k}V=0 for all k>n.

If k≦n a basis for Λ^{k}V consists of k-vectors of the form
σ¹^{₁}Λσ^{u}^{₂}Λ . . . Λσⁱ^{ₖ}
where i₁<i₂< . . . iₖ. Then

$$dim {Λ}^{k} V = ( \begin{matrix}n \\ k\end{matrix} )$$

The k-vector of a polyhedral chain. ([2], III) A k-cell σ determines a unique k-direction. This, together with its k-volume M(σ) determine a unique simple k-vector denoted Vec(σ) with the same mass and direction. Define the k-vector of an algebraic k-chain A=Σαᵢσᵢ by Vec(A):=ΣαᵢVec(σᵢ). For k=0 define Vec(Σaᵢpᵢ):=Σaᵢ. This definition extends to a polyhedral k-chain P since the k-vector of any chain equivalent to a k-cell is the same as the k-vector of the k-cell. The main purpose of introducing Vec(A) in this paper is to show that the important k-elements defined below in Chapter 7 are, in fact, well defined.

PROPOSITION 2.1. If P is a polyhedral k-chain then Vec(∂P)=0.

PROOF. This follows since Vec(∂σ)=0 for every k-cell σ. □

THEOREM 2.2. Vec is a linear operator
Vec: Pₖ→Λ^{k}( [symbol] ⁿ)
with
M(Vec(P))≦M(P)
for all P ε Pₖ.

PROOF. This follows since M(Vec(σ))=M(σ) for every k-cell σ.

Exterior product of j- and k-vectors. Define
Λ: (Λ^{j}V)×(Λ^{k}V)→Λ^{j+k}V
by
Λ(α₁Λ . . . Λαⱼ,β₁Λ . . . Λβₖ)=α₁Λ . . . ΛαⱼΛβ₁Λ . . . Λβₖ.
This product is distributive, associative and anticommutative:
μΛλ=(−1)^{jk}λΛμ.
Exercise: Prove that all k-vectors in Λ^{k}( [symbol] ⁿ) are simple k-vectors for n≦3. Show this fails for n=4 by showing that (e¹Λe²)+(e³Λe⁴) is not simple.

Oriented k-direction of a simple k-vector. Define the k-direction of a simple k-vector α to be the k-dimensional subspace of the vectors α¹, . . . , α^{k} that determine α=α¹Λ . . . Λα^{k}. This subspace inherits an orientation from α as follows: Two bases of a vector space V are equivalent if and only if the matrix relating them has positive determinant. An equivalence class of bases is called an orientation. There are only two orientations of V and we choose one of them and fix it, once and for all. We say a basis is positively or negatively oriented, according as to whether it has the chosen orientation. A subspace of V has no preferred orientation but it makes sense to give the k-direction of a simple k-vector the same or opposite orientation as α. If we give it the same orientation as α, we obtain the oriented k-direction of α.

Standard operators on V such as linear transformations, inner products and determinants naturally extend to corresponding structures and operators on Λ^{k}V. For example, if T:V→W is linear then the transformation Λ^{k}(T): Λ^{k}(V)→Λ^{k}(W) defined on simple k-vectors α=α₁Λα₂Λ . . . Λαₖ by
Λ^{k}T(α)=T(α₁)ΛT(α₂)Λ . . . ΛT(αₖ)
is linear. Extend Λ^{k}T to k-vectors by linearity.

### Inner Product Spaces

An inner product on a vector space V is a real-valued function on V×V which is symmetric positive definite bilinear form. An example is the Euclidean inner product on [symbol] ⁿ given by <α,β>=Σaᵢbᵢ where α=(a₁, . . . aₙ) and β=(b₁, . . . bₙ). An orthonormal basis of V consists of a basis σ¹, . . . , σⁿ do such that
<σⁱ,σ^{j}>=δ^{ij}.
Suppose V is an inner product space. We define an inner product for simple vectors α, βεΛ^{k}V as follows:
<α,β>:=det(<αᵢ, βⱼ>)
where α=α₁Λα₂Λ . . . αₖ and β=β₁Λβ₂Λ . . . βₖ. Since determinant is an alternating, k-multilinear function of the α's and β's we obtain a scalar valued function, linear in each variable
<, >: Λ^{k}V×Λ^{k}V→ [symbol]
Note that <α,β>=<β,α> since the determinant of the transpose of a matrix is the same as the determinant of the matrix.

It is left to show that the inner product is well defined.

Orthonormal basis of Λ^{k}V. Choose an orthonormal basis {e¹, . . . eⁿ} of V. For H {h₁, h₂, . . . , hₖ}, let
e^{H}:=e^{h}^{₁}Λe^{h}^{₂}Λ . . . Λe^{h}^{ₖ}.
Then the collection of simple k-vectors
{e^{H}: H={h₁<h₂< . . . <hₖ}}
forms a basis of Λ^{k}V.

Mass of α. For a simple k-vector α, define M(α)=\sqrt{<α,α>}.

Volume elements. If V is an inner product space, the volume element vol is well defined (with respect to the chosen orientation). It is the unique n-vector in ΛⁿV with
vol=e¹Λe²Λ . . . Λeⁿ
where (eⁱ) is a positively oriented orthonormal basis. Observe that M(vol)=1.
Exercise {e^{H}} is an orthonormal basis of Λ^{k}V. (Hint: H≠L [symbol] the matrix has a row of zeroes. H=L [symbol] all but the diagonal elements vanish. Thus <e^{H}, e^{J}>=±1 if H and J contain the same indices with no repeats, and is zero, otherwise. In particular, vol=e¹ Λ . . . Λ eⁿ is an orthonormal basis of ΛⁿV and <vol, vol >=1.

The k-vector {Pₖ} of each Pₖ in exercise of Chapter 1 is the volume element in [symbol] ².

### Two Basic Examples

Example 1. The oriented k-direction of an oriented k-dimensional parellelopiped P is the oriented k-subspace generated by the vectors that determine P. We create equivalence classes of oriented k-parallelopipeds P in [symbol] ⁿ. We say that P˜Q if P and Q have the same k-volume and oriented k-direction. We take formal sums of these classes to form a vector space Pₖ. Clearly, there is a 1-1 correspondence between simple k-vectors and equivalence classes of parallelepipeds with a given oriented k-direction and k-volume, or mass. The notion of taking products of k-vectors and making k-parallelograms justifies the use of the term bfserires itshape exterior product since the k-parallelogram takes up space exterior to its defining vectors. Later, we will see an interior product where the parallelogram created is interior to its defining vectors. The term exterior, associated to the first definition given in these notes, the exterior product, is used throughout the subject. We will see exterior derivatives, exterior algebra, exterior chainlets. Each time you see the term you should expect to see the exterior product playing a major role. For example the exterior algebra is called an algebra because it comes with a product, namely the exterior product.

THEOREM 2.3. There is a canonical isomorphism
θ: Λ^{k}( [symbol] ⁿ)→Pₖ
such that the k-dimensional volumes and oriented k-directions of P and θ(P) are the same.

We assume all k-vectors and k-directions are oriented and usually omit the term “oriented”.

This result gives us a simple geometric way to view Λ^{k}( [symbol] ⁿ) and will help us visualize operators and products as we go along. However, an important feature missing from this representation is that there is no canonical representative of a k-vector within a class of parallelopipeds. In particular, one cannot define the boundary of a k-vector. An important goal of these notes is to resolve this problem.

Example 2. The differential dxⁱ of [symbol] ⁿ is defined to be the linear functional on [symbol] ⁿ given by dxⁱ(x¹e¹+ . . . +xⁿeⁿ):=xⁱ. Let Dⁿ denote the linear space generated by differentials {dx¹, dx², . . . , dxⁿ} of [symbol] ⁿ. The space Λ^{k}(Dⁿ) is of special interest. We follow the common practice of omitting the wedge sign for k-vectors e.g., dxⁱΛdx^{j}=dxⁱdx^{j}. These k-vectors of differentials exist since they do so for any vector space. The theorem tells us what they are—linear functionals of k-vectors of [symbol] ⁿ.

THEOREM 2.4. The mapping α^{H}dx^{H} [symbol] a^{H}e^{H} induces an isomorphism
Λ^{k}(Dⁿ)≅(Λ^{k} [symbol] ⁿ)′.

### Differential Forms

A differential k-form w on U ⊂ [symbol] ⁿ is an element of the dual space of Λ^{k}( [symbol] ⁿ) for each p ε U,
ω:U×Λ^{k}( [symbol] ⁿ)→ [symbol]
* In these notes, we define three basic operators on forms as dual to corresponding operators on k-vectors: Hodge star *ω, pullback f*ω and exterior derivative dω:
*In GC we define operators on differential forms as dual to geometric operators on k-vectors α defined at each point, without integrating, whereas GMT defines operators on domains (currents) as dual to operators defined analytically on differential forms.

*ω(p,α):=ω(p,*α)
f*ω(p,α):=ω(p,f*α)
*dω(p,α):=ω(p,∂α)
   We are reduced to defining three geometric operators on simple k-vectors αεΛ^{k}( [symbol] ⁿ)—the star operator *α, pushforward f_{*}α and boundary ∂α. Star of a simple k-vector will be presented in this section. We postpone defining the boundary ∂α of a simple k-vector α until the lecture on discrete calculus. The idea of the boundary of a k-vector is a new and important concept introduced in these notes.

THEOREM 2.5. If T: [symbol] ⁿ→ [symbol] ⁿ is a linear transformation and αεΛ^{k}( [symbol] ⁿ) then
Λ^{k-1}T(∂α)=∂(Λ^{k}T(α)).

The definitions and proof will be postponed until Lecture III as the natural norm is needed to define the boundary of a k-vector in L^{k}( [symbol] ⁿ).

Pullback of a differential form. Suppose f: U ⊂ [symbol] ⁿ→V⊂ [symbol] ⁿ is smooth. Denote the Jacobian matrix of partial derivatives evaluated at pεU by Dfₚ. This, of course is a linear transformation Dfₚ: [symbol] ⁿ→ [symbol] ⁿ. We will denote
D^{k}fₚ:=Λ^{k}(Dfₚ): Λ^{k}( [symbol] ⁿ)→Λ^{k}( [symbol] ⁿ).
Observe that if α is a k-vector then D^{k}fₚ(α) is a well defined k-vector called the pushforward of α under f. The pullback of a k-form ω in V is a k-form f *ω in U defined by
f*ω(p,α):=ω(f(p), D^{k}fₚ(α)).

LEMMA 2.6. If f: U⊂ [symbol] ⁿ→V⊂ [symbol] ⁿ is smooth and ω is a differential k-form then
1. f*(ω+η)=f*ω+f*η;
2. f*(αΛβ)=f*αΛf*,β;
3. df*=f*d
4. (g∘f)*=f*∘g*

PROOF.
1. follows since D^{k}f^{p} is linear.
2. follows since D^{k}fₚ acts on a k-vector α=α¹Λ . . . Λα^{k} by way of the linear transformation Dfₚ applied to each aⁱ.
3.
   df*ω(p,α)=f*ω(p,∂(α))=ω(f(p), D^{k-}fₚ(∂α)).

On the other hand, by Theorem 2.5

$$\begin{matrix}f * dw ( p , α ) = dw ( f ( p ) , {D}^{k} {f}_{p} ( α ) ) \\ = w ( f ( p ) , \partial {D}^{k} {f}_{p} ( α ) ) \\ = w ( f ( p ) , {D}^{k} {f}_{p} ( p \partial α ) ) .\end{matrix}$$

4.

$$\begin{matrix}( g \cdot f ) * w ( p , α ) = w ( g \cdot f ( p ) , {{D}^{k} ( g \cdot f )}_{p} ( α ) ) \\ = w ( g \cdot f ( p ) , {D}^{k} {g}_{f ( p )} {D}^{k} {f}_{p} ( α ) ) \\ = {f}^{*} \cdot {g}^{*} w ( p , α ) .\end{matrix}$$

Examples. 1. Let f: [symbol] ²→ [symbol] be defined by f(x, y)=x−y and ω=dt a 1-form on [symbol] . Then

$$\begin{matrix}f * w ( ( x , y ) , ( {a}^{1} , {a}^{2} ) ) = w ( f ( x , y ) , D {f}_{x , y} ( {a}^{1} , {a}^{2} ) ) \\ = dt ( x - y , {a}^{1} - {a}^{2} ) \\ = {a}^{1} - {a}^{2} \\ = ( dx - dy ) ( {a}^{1} , {a}^{2} ) .\end{matrix}$$

Therefore f*dt=dx−dy.

Remark. The standard approach (commonly unjustified) is
t=x−y [symbol] dt=dx−dy.

2. Let f(t): [symbol] ¹→ [symbol] ² be defined by f(t)=(t²,t³). Let ω be the 1-form in [symbol] ² given by ω=xdy. Then

$$\begin{matrix}f * w ( t , 1 ) = w ( f ( t ) , {Df}_{t} ( 1 ) ) \\ = w ( ( {t}^{2} , {t}^{3} ) , ( 2 t , 3 {t}^{2} ) ) \\ = xdy ( ( {t}^{2} , {t}^{3} ) , ( 2 t , 3 {t}^{2} ) ) \\ = {t}^{2} 3 {t}^{2} \\ = 3 {t}^{4} dt ( t , 1 ) .\end{matrix}$$

Therefore f*(xdy)=3t⁴dt.

Hodge star dual. Given a simple k-vector α, we wish to find a canonical simple (n−k)-vector *α such that αΛ*α=M(α)²vol.

We further require that the (n−k)-direction of *α be perpendicular to the k-direction of α. We are reduced to showing existence and uniqueness.

For this, we recall the Riesz representation theorem:

THEOREM 2.7. Suppose V is an inner product space and f ε V* is a linear functional. There exists a unique ωεV such that
f(υ)=<υ,ω>.

PROOF. Let e¹, . . . , eⁿ be orthonormal. Set bᵢ:=f(eⁱ). Set ω=Σbⱼe^{j}. Then <eⁱ,ω>=bᵢ=f(eⁱ).

Now fix αεΛ^{k}V. For βεΛA^{n-k} the mapping β [symbol] αΛβ is a linear transformation
Λ^{n-k}→Λⁿ.
The latter space has dimension one. Therefore one may define f_{α}(β) by
αΛβ=f_{α}(β)vol
where f_{α} is a linear functional on Λ^{n-k}V. According to Theorem 2.7 there exists a unique (n−k)-vector *α such that
αΛμ=<*α,μ> vol
for all μεΛ^{n-k}.

LEMMA 2.8. For simple α the (n−k)-direction of *α is the orthogonal complement of the k-direction of α, oriented so that αΛ*α is positively oriented.

In particular

$$\begin{matrix}α ⋀ * α = {( - 1 )}^{k ( n - k )} * α ⋀ α \\ = {( - 1 )}^{k ( n - k )} < ** α , α > vol \\ = {( - 1 )}^{k ( n - k )} {( - 1 )}^{k ( n - k )} < α , α > vol \\ = {M ( α )}^{2} vol .\end{matrix}$$

LEMMA 2.9. If α,β are k-vectors then

1. ** α=(−1)^{k(n-k)}α.

2. αΛ*β=βΛ*α=<α,β> vol

If ω is a differential k-form, define the Hodge star dual *ω as
*ω(p,α):=ω(p,*α)
for all (n−k)-vectors α. If ω is a k-form we know that ω=ω¹Λ . . . Λω^{k} where the ωⁱ are 1-forms. Each ωⁱ corresponds to a vector ωⁱ from the above exercise.

PROPOSITION 2.10. Assume ω=ω¹Λ . . . Λω^{k} is a simple k-form. Then (*ω)(υ¹Λ . . . Λυ^{n-k}) is the volume of the n-parallelogram spanned by υ¹, . . . , υ^{n-k}, ω¹, . . . ω^{k}.

### CHAPTER 3

### Differential Forms and Chainlets

### Isomorphisms of Differential Forms and Cochains

We recall two classical results from integral calculus:

THEOREM 3.1 (Classical Stokes' theorem). If P is a polyhedral k-chain and ω is a smooth k-form defined in a neighborhood of P then
∫_{∂P}ω=∫_{P}dω.

THEOREM 3.2 (Classical change of variables). If P is a polyhedral k-chain, ω is a smooth k-form and f is an orientation preserving diffeomorphism defined in a neighborhood of P then
∫_{fP}ω=∫_{P}f*ω.

The flat norm. Whitney's flat norm [2] on polyhedral chains A ε Pₖ is defined as follows:
|A|=inf{M(B)+M(C): A=B+∂C, BεPₖ, CεPₖ₊₁}.

Flat k-forms ([2], 12.4) are characterized as all bounded measurable k-forms ω such that there exists a constant C>0 such that sup |∫_{σ}ω|<CM(σ) for all k-cells σ and sup |∫_{∂T}ω|<CM(τ) for all (k+1)-cells τ. The exterior derivative dω of a flat form ω is defined a.e. and satisfies
∫_{∂τ}ω=∫_{τ}dω.
Exercises

1. Prove that the form

$$w = \{ \begin{matrix}dx - dy , & x > y \\ 0 , & x \leq y\end{matrix}$$

is flat but the form

$$η = \{ \begin{matrix}dx + dy , & x > y \\ 0 & x \leq y\end{matrix}$$

is not flat. (Hint. Consider small squares with centers on the diagonal.) Thus ω is smoothly homotopic to a form that is not flat. Show that there are forms arbtirarily close to ω that are not flat. Show that the components of ω are not flat.

We conclude that the flat topology is limited at the level of chains and cochains. (Comment for experts: Some problems disappear at the level of homology and cohomology.)

2. Let P be the boundary of a rectangle with bottom edge length 10 and side length 0.1. Let Q be the same curve without one of the short edges. Show that |P|^{b}, <|Q|^{b}.

The support of a differential form is the closure of the set of all points p ε [symbol] ⁿ such that ω(p) is nonzero. Let U be an open subset of [symbol] ⁿ and ω be a bounded measurable k-form whose support is contained in U. In what follows, let σ denote a k-cell and τ a (k+1)-cell.

Define

$${‖ w ‖}_{0} := sup \{ \frac{{\int }_{σ} w}{M ( σ )} \text{:} σ ⋐ sptw \} .$$

Inductively define

$${‖ w ‖}_{T} := sup \{ \frac{{‖ w - {T}_{υ} w ‖}_{r - 1}}{\vert υ \vert} \text{:} spt ( w - {T}_{υ} w ) ⋐ U \} .$$

Define

$${‖ ω ‖}_{0}^{′} \text{:} = sup \{ \frac{{\int }_{{\partial }_{τ}} ω }{M ( τ )} \text{:} τ ⋐ sptw \}$$

and

$${‖ ω ‖}_{r}^{′} \text{:} = sup \{ \frac{{‖ ω - {T}_{υ} ω ‖}_{r - 1}^{′} }{\vert υ \vert} \text{:} spt ( ω - {T}_{υ} ω ) ⋐ U \} .$$

Define
|ω|₀:=∥ω∥₀
and for r≧1,
|ω|ᵣ:=maX{∥ω∥₀, . . . , ∥ω∥ᵣ, ∥dw∥₀, . . . , ∥ω∥ᵣ₋₁}.
We say that ω is of class B^{r} if |ω|ᵣ<∞. Let Bₖ^{r} denote the space of differential k-forms of class Br.

LEMMA 3.3. If |ω|₁<∞ then dω is defined a.e. Furthermore,
∫_{∂σ}ω=∫_{σ}dω

PROOF. If |ω|₁∞ then ω is a flat form. It follows from ([2], 12.4) that dω is defined a.e. and satisfies Stokes' theorem on cells.

LEMMA 3.4. If ωεBₖ^{r}, r≧1, then
|ω|ᵣ=max{∥ω∥₀, . . . , ∥ω∥ᵣ, ∥dω∥₀, . . . , ∥dω∥ᵣ₋₁}.

Therefore
|dω|ᵣ₋₁≦|ω|ᵣ. (1)

Remark. On a smooth manifold these norms are equivalent to the C^{τ-1+LiP} norms of analysis. That is, the (r−1)-derivatives exist and satisfy Lipschitz conditions. However, the norms can also be defined on Lipschitz manifolds where one cannot speak of higher derivatives. We only know that derivatives of Lipschitz functions exist almost everywhere. However, a constant function is of class B^{r} for all r, even on a Lipschitz manifold. This opens the possibility of extending chainlet geometry to Lipschitz Riemannian manifolds which we will develop in a later chapter. (We must be able to define divergence free vector fields, exterior derivative and star operator a.e.)

The next result generalizes the standard integral inequality of calculus:
|∫_{P}ω|≦M(P)|ω|₀
where P is polyhedral and ω is a bounded, measurable form.

THEOREM 3.5 (Fundamental integral inequality of chainlet geometry). Let P ε Pₖ, r ε [symbol] ⁺, and ωε βₖ^{r} be defined in a neighborhood of spt(P). Then
|∫_{P}ω|≦|P|^{♮r}|ω|ᵣ.

PROOF. We first prove |∫_{σ}_{^{j}}ω|≦∥σ^{j}∥ⱼ∥ω∥ⱼ. Since ∥ω∥₀=|ω|₀ we know
|∫_{σ}_{⁰}ω|≦M(σ⁰)|ω|₀=∥σ⁰∥₀∥ω∥₀.

Use the change of variables formula 3.2 for the translation T_{υ}_{ⱼ} and induction to deduce

$$\begin{matrix}\vert {\int }_{{σ}^{j}} ω \vert = \vert {\int }_{{σ}^{j - 1} - {T}_{{υ}_{j}} {σ}^{j - 1}} ω \vert \\ = \vert {\int }_{{σ}^{j - 1}} ω - {T}_{{υ}_{j}}^{*} ω \vert \leq {‖ {σ}^{j - 1} ‖}_{j - 1} {‖ ω - {T}_{{υ}_{j}}^{*} ω ‖}_{j - 1} \leq \\ {‖ {σ}^{j - 1} ‖}_{j - 1} {‖ ω ‖}_{j} \vert {υ}_{j} \vert \\ = {‖ {σ}^{j} ‖}_{j} {‖ ω ‖}_{j}\end{matrix}$$

By linearity
|∫_{D}εDₖ^{j}.
for all D^{j}εDₖ^{j},

We again use induction to prove |∫_{P}ω|≦|P|^{♮r}|ω|_{τ}. We know |∫_{P}ω|≦|P|^{♮0}ω|₀. Assume the estimate holds for r−1.

Let ε>0. There exists

$$P = {\sum }_{j = 0}^{r} {D}^{j} + \partial C$$

such that

$${\vert P \vert}^{{♮}_{r}} > {\sum }_{j = 0}^{r} {‖ {D}^{j} ‖}_{j} + {\vert C \vert}^{{♮}_{r - 1}} - ɛ .$$

By Stokes' theorem for polyhedral chains, inequality (1) and induction

$$\vert {\int }_{P} ω \vert \leq {\sum }_{j = 0}^{r} \vert {\int }_{{D}^{j}} ω \vert + \vert {\int }_{C} ⅆ ω \vert \leq {\sum }_{j = 0}^{r} {‖ {D}^{j} ‖}_{j} {‖ ω ‖}_{j} + {\vert C \vert}^{{♮}_{r - 1}} {\vert ⅆ ω \vert}_{r - 1} \leq ( {\sum }_{j = 0}^{r} {‖ {D}^{j} ‖}_{j} + {\vert C \vert}^{{♮}_{r - 1}} ) {\vert ω \vert}_{r} \leq ( {\vert P \vert}^{{♮}_{r}} + ɛ ) {\vert ω \vert}_{r} .$$

Since the inequality holds for all ε>0 the result follows.

COROLLARY 3.6. |P|^{♮r} is a norm on the space of polyhedral chains Pₖ.

PROOF. Suppose P≠0 is a polyhedral chain. There exists a smooth differential form ω such that ∫_{P}ω≠0. Then 0<|∫_{P}ω|≦|P|^{♮r}|ω|ᵣ implies |P|^{♮r}>0.

The Banach space of polyhedral k-chains Pₖ completed with the norm | |^{♮r} is denoted Nₖ^{r}. The elements of Nₖ^{r} are called k-chainlets of class N^{r}.

It follows from Proposition 1.1 that the boundary ∂A of a k-chainlet A of class N^{r} is well defined as a (k−1)-chainlet of class N^{r+1}. If Pᵢ→A in the r-natural norm define

$$\partial A \text{:} = {lim}_{i \to ∞} \partial {P}_{i} .$$

By Theorem 3.5 the integral ∫_{A}ω is well defined for k-chainlets A of class N^{r} and differential k-forms of class B^{r}. If Pᵢ→A in the r-natural norm define

$${\int }_{A} ω \text{:} = {lim}_{i \to ∞} {\int }_{{P}_{i}} ω .$$

THEOREM 3.7. [Generalized Stokes' theorem] If A is a k-chainlet of class N^{r} and ω is a (k−1)-form of class B^{r+1} defined in a neighborhood of sptA then
∫_{∂A}ω=∫_{A}^{dω.}

PROOF. Choose polyhedral Pᵢ→A in the r-natural norm. By Stokes' theorem for polyhedral chains
∫_{A}dω=lim ∫_{P}_{ᵢ}dω=lim ∫_{∂P}_{ᵢ}ω=lim ∫_{∂A}ω.

Later, in the discrete chapter, we give a proof without relying on the classical Stokes' theorem for polyhedral chains.

Examples of Chainlets

1. The boundary of any bounded, open subset U of [symbol] ⁿ. One may easily verify that the boundary of any bounded, open set U ⊂ [symbol] ⁿ, such as the Van Koch snowflake, supports a well defined chainlet B=∂U of class N¹. Suppose the frontier of U has positive Lebesgue area. Then the chainlet B′=∂( [symbol] ⁿ−\overline{U}) has the same support as B, namely the frontier of U, but since B+B′ bounds a chainlet with positive mass it follows that B and −B′ are distinct.
2. Graphs of functions The graph of a nonnegative L¹ function f: K ⊂ [symbol] ⁿ→ [symbol] supports a chainlet Γ_{f} if K is compact. This can be seen by approximating Γ_{f} by the polyhedral chains Pₖ determined by a sequence of step functions gₖ approximating f. The difference Pₖ−Pₖ₊ⱼ is a 1-difference k-cellular chain. The subgraph of a nonnegative function f is the area between the graph of f and its domain. Since the subgraph of f has finite area, it follows that ∥Pₖ−Pₖ₊ⱼ∥₁→0 as j, k→∞. Hence, the sequence Pₖ is Cauchy in the 1-natural norm. The boundary ∂Γ_{f} is a chainlet that identifies the discontinuity points of f.

Later, we will define the natural norms and develop a full theory of integration from first principles, without reference to the classical Stokes' theorem or even the Riemann integral.

### The Banach Space Nₖ^{∞} of Chainlets

It can be easily shown that the r-natural norms satisfy the inequalities
|P|^{♮0}≧|P|^{♮0}≧|P|^{♮2}≧ . . .
for any polyhedron P. It follows that there are natural inclusion mappings ηᵣ: Nₖ^{r}→Nₖ^{r+1} defined as follows: If A ε Nₖ^{r} then A=lim Pⱼ in the r-natural norm. Define ηᵣ(A):=lim Pⱼ in the (r+1)-natural norm.

For P a polyhedral chain define

$${\vert P \vert}^{♮} \text{:} = {lim}_{r \to ∞} {\vert P \vert}^{{♮}_{r}} .$$

This limit exists since the r-natural norms are decreasing.

THEOREM 3.8. | |^{♮} is a norm on polyhedral chains.

PROOF. If P, Q ε Nₖ^{∞} then

$$\begin{matrix}{\vert P + Q \vert}^{♮} = {lim}_{r \to ∞} {\vert P + Q \vert}^{{♮}_{r}} \leq {lim}_{r \to ∞} sup ( {\vert P \vert}^{{♮}_{r}} + {\vert Q \vert}^{{♮}_{r}} ) \\ = {lim}_{r \to ∞} {\vert P \vert}^{{♮}_{r}} + {lim}_{r \to ∞} {\vert Q \vert}^{{♮}_{r}} \\ = {\vert P \vert}^{♮} + {\vert Q \vert}^{♮}\end{matrix}$$

and

$${\vert λ P \vert}^{♮} = {lim}_{r \to ∞} {\vert λ P \vert}^{{♮}_{r}} = \vert λ \vert {lim}_{r \to ∞} {\vert P \vert}^{{♮}_{r}} = \vert λ \vert {\vert P \vert}^{♮} .$$

Clearly, P=0 [symbol] |P|^{♮}=0. It remains to show |P|^{♮}≠0 [symbol] P≠0 for a polyhedron P. But if P is a nonzero polyhedral chain, there exists a smooth form w and a constant C>0 such that ∫_{P}ω≠0 and |ω|ᵣ<C for all r. Then 0<|∫_{P}ω|≦|P|^{♮r}|ω|ᵣ<C|P|^{♮r} for each r. It follows that |P|^{♮}≧|∫_{P}ω|/C>0.
We call elements of the Banach space Nₖ^{∞} obtained upon completion k-chainlets of class N^{∞} or, more simply, k-chainlets.

THEOREM 3.9. If A is a chainlet in [symbol] ⁿ and υε [symbol] ⁿ then
|A−T_{υ}A|^{♮}≦|υ||A|^{♮}.

Hence translation of a chainlet converges uniformly to 0 as a function of A and υ.

PROOF. Let Pᵢ→A. Then Pᵢ−T_{υ}Pᵢ→T_{υ}A. It follows that
|A−T_{υ}A|^{♮}=lim |Pᵢ−T_{υ}Pᵢ|^{♮}≦|υ||Pᵢ|^{♮}→|υ||A|^{♮}.

THEOREM 3.10.
|∂A|^{♮}≦|A|^{♮}.

PROOF.

$${\vert \partial A \vert}^{♮} = {lim}_{r \to ∞} {\vert \partial A \vert}^{{♮}_{r}} \leq {lim}_{r \to ∞} {\vert A \vert}^{{♮}_{r - 1}} = {\vert A \vert}^{♮} .$$

In these lectures we introduce a number of operators on chainlets all of which are bounded in the chainlet spaces. The Banach spaces of chainlets are not reflexive since they are separable and differential forms are not separable [7]. Thus N^{♮} is strictly contained in (N^{♮})**. Now operators dual to operators on differential forms automatically send chainlets into the double dual space. It is surprising that the operators map N^{♮} into itself.

Characterization of the Banach Space of Chainlets.

THEOREM 3.11. Suppose | |′ is a seminorm of polyhedral chains satisfying

1. |∂D⁰|′≦|D⁰|^{♮r-1} and

2. |Dⁱ|′≦∥Dⁱ∥ᵢ for all multicellular chains Dⁱ and 0≦i≦r.

Then |P|′≦|P|^{♮r} for all polyhedral chains P.

PROOF. For r≧1, if ε>0 there exists a decomposition

$$P = {\sum }_{i = 0}^{r} {D}^{i} + \partial C$$

such that

$${\vert P \vert}^{{♮}_{r}} > {\sum }_{i = 0}^{r} {‖ {D}^{i} ‖}_{i} + {\vert C \vert}^{{♮}_{r - 1}} - ɛ .$$

By assumption

$${\vert P \vert}^{′} \leq {\sum }_{i = 0}^{r} {\vert {D}^{i} \vert}^{′} + {\vert \partial C \vert}^{′} \leq {\sum }_{i = 0}^{r} {‖ {D}^{i} ‖}_{i} + {\vert C \vert}^{{♮}_{r - 1}} < {\vert P \vert}^{{♮}_{r}} + ɛ .$$

The result follows O

COROLLARY 3.12.

$${\vert A \vert}^{{♮}_{r}} = inf \{ \begin{matrix}{\sum }_{i = 0}^{r} {‖ {D}^{i} ‖}_{i} + {\vert C \vert}^{{♮}_{r - 1}} \text{:} \\ A = {\sum }_{i = 0}^{r} {D}^{i} + \partial C , {D}^{i} ∈ {𝒩}^{{♮}_{r}} , C ∈ {𝒩}^{{♮}_{r - 1}}\end{matrix} \} .$$

PROOF. Denote the rhs by |A|_{<r>}. This is clearly a seminorm. By the characterization of the r-natural norm, we know that |A|_{<r>}≦|A|^{♮r}.

Let ε>0. There exists A=ΣDⁱ+∂C, Dⁱ ε N^{♮r}, C ε N^{♮r-1} such that

$${\vert A \vert}_{< r >} > {\sum }_{i = 0}^{r} {‖ {D}^{i} ‖}_{i} + {\vert C \vert}^{{♮}_{r - 1}} - ɛ .$$

Then

$$\begin{matrix}{\vert A \vert}^{{♮}_{r}} \leq \sum {\vert {D}^{i} \vert}^{{♮}_{r}} + {\vert C \vert}^{{♮}_{r - 1}} = \sum {\vert {D}^{i} \vert}_{r} + {\vert C \vert}^{{♮}_{r - 1}} \leq \\ \sum {\vert {D}^{i} \vert}_{i} + {\vert C \vert}^{{♮}_{r - 1}} \leq \\ \sum {‖ {D}^{i} ‖}_{i} + {\vert C \vert}^{{♮}_{r - 1}} < {\vert A \vert}_{< r >} + ɛ .\end{matrix}$$

COROLLARY 3.13. The natural norm is the largest seminorm in the class of seminorms satisfying

1. |A|′≦M(A),

2. |∂A|′≦|A|′ and

3. |A−T_{υ}A|′≦|υ||A|′.

PROOF. First observe that conditions (1) and (3) imply |Dⁱ|′≦∥Dⁱ∥ᵢ for all multicellular chains Dⁱ and 0≦i≦r. We know |D⁰|′≦∥D⁰∥₀ by (1). Assume the claim holds for i−1. By (3) and the induction hypothesis
|σⁱ|′=|σⁱ⁻¹−T_{υ}σⁱ⁻¹|′≦|υ||σⁱ⁻¹|′≦|υ|∥σⁱ⁻¹∥ᵢ₋₁=∥σⁱ∥ᵢ.
The claim is established by taking linear combinations.

Let P be a polyhedral chain. Given ε>0 there exists r such that
|P|^{♮}>|P|^{♮r}−ε/2
and a decomposition P=ΣDⁱ+∂C such that
|P|^{♮r}>Σ∥Dⁱ∥ᵢ+|C|^{♮r-1}−ε/2.
Hence
|P|^{♮}>Σ∥Dⁱ∥ᵢ+|C|^{♮r-1}−ε.

If k=n then the same inequality holds, except we set C=0 since C has dimension n+1. In this case we have
|P|′≦Σ|Dⁱ|′≦Σ∥Dⁱ∥ᵢ<|P|^{♮+ε.}
Since the result holds for all ε>0 we conclude |P|′≦|P|^{♮}. Now assume the result holds for polyhedral k-chains C, we prove it holds for polyhedral (k−1)-chains P.

Thus by induction

$${\vert P \vert}^{′} \leq \sum {\vert {D}^{i} \vert}^{′} + {\vert \partial C \vert}^{′} \leq \sum {‖ {D}^{i} ‖}_{i} + {\vert C \vert}^{′} \leq \sum {‖ {D}^{i} ‖}_{i} + {\vert C \vert}^{♮} \leq \sum {‖ {D}^{i} ‖}_{i} + {\vert C \vert}^{{♮}_{r - 1}} < {\vert P \vert}^{♮} + ɛ .$$

Let X be a Banach space with norm | |′. We say an operator S: X→X is is Lipschitz bounded if there exists K>0 such that |S(A)|′≦K|A|′ for all A ε X. An operator S: X× [symbol] ⁿ→X is Lipschitz bounded if there exists K>0 such that |S(A,υ)|′≦K|υ||A|′ for all A ε X and υ ε Rⁿ. Two examples that interest us are the translation operator S(A, υ)=A−T_{υ}A and the boundary operator S(A)=∂A. We assume K=1 in what follows as different constants lead to the same Banach space.

Let X′ be the completion of the space of polyhedral chains with the mass norm.

COROLLARY 3.14. The Banach space of chainlets is the smallest Banach space containing X⁰ and which has Lipschitz bounded boundary and translation operators.

Characterization of cochains as differential forms. The r-natural norm of a cochain X ε (N^{r})′ is defined by

$${\vert X \vert}^{{♮}_{r}} \text{:} = {sup }_{P ∈ p} \frac{\vert X \cdot P \vert}{{\vert P \vert}^{{♮}_{r}}} .$$

The differential operator d on cochains is defined as the dual to the boundary operator dX·A :=X·∂A. It remains to show how cochains relate to integration of differential forms and how the operator d given above relates to the standard exterior derivative of differential forms. If X ε (Nₖ^{r})′ then dX ε (Nₖ₊₁^{r-1})′ by Lemma 1.1.

Cochains and differential forms. In this section we show the operator Ψ mapping differential forms of class B^{r} into the dual space of chainlets of class N^{r} via integration
Ψ(ω)·A:=∫_{A}ω
is a norm preserving isomorphism of graded algebras.

It follows from Theorem 3.5 that Ψ(ω) ε (Nₖ^{r})′ with
|Ψ(ω)|^{♮r}≦|ω|ᵣ.

THEOREM 3.15 (Extension of the theorem of de Rham). Let r≧0. To each cochain X ε (Nₖ^{r})′ there corresponds a unique differential form φ(X) ε Bₖ^{r} such that ∫_{σ}φ(X)=X·σ for all cells σ. This correspondence is an isomorphism with
|X|^{♮r}=|φ(X)|ᵣ.
If r≧1 then
φ(dX)=dφ(X).
This is proved in [8].

COROLLARY 3.16. If A, B ε Nₖ^{r} satisfy
∫_{A}ω=∫_{B}ω
for all ω ε Bₖ^{r} then A=B.

PROOF. Let X ε (Nₖ^{r})′. By Theorem 3.15 the form φ(X) is of class B^{r}. Hence
X·(A−B)=∫_{A-B}φ(X)=0.
It follows that A=B.

COROLLARY 3.17. If A ε Nₖ^{r}; then

$${\vert A \vert}^{{♮}_{r}} = sup \{ {\int }_{A} ω \text{:} ω ∈ {B}_{k}^{r} , {\vert ω \vert}_{r} \leq 1. \}$$

PROOF. By Theorem 3.15

$$\begin{matrix}{\vert A \vert}^{{♮}_{r}} = sup \{ \frac{\vert X \cdot A \vert}{{\vert X \vert}^{{♮}_{r}}} \text{:} X ∈ {( {𝒩}_{k}^{r} )}^{′} \} \\ = sup \{ \frac{\vert {\int }_{A} ϕ ( X ) \vert}{{\vert ϕ ( X ) \vert}_{r}} \text{:} ϕ ( X ) ∈ {B}_{k}^{r} \} \\ = sup \{ \frac{\vert {\int }_{A} ω \vert}{{\vert ω \vert}_{r}} \text{:} ω ∈ {B}_{k}^{r} \} .\end{matrix}$$

Cup product. Given a k-cochain X and a j-cochain Y, we define their cup product as the (j+k)-cochain
X∪Y :=Ψ(φ(X)Λφ(Y)).
The next result follows directly from Theorem 3.15.

LEMMA 3.18. Given X ε (Nₖ^{r})^{l} and Y ε (Nⱼ^{r}j)^{l} the cochain X∪Y ε (Nₖ₊ⱼ^{r}(Rⁿ))^{l} with
|X∪Y|^{♮r}=|φ(X)Λφ(Y)|ᵣ.
Furthermore
φ(X∪Y)=φ(X)Λφ(Y).

THEOREM 3.19. If X ε (Nₖ^{r})′, Y ε (Nⱼ^{r})′, Z ε (Nₗ^{r})′, and f ε B₀^{r+1 then}
(i) |X∪Y|^{♮r}≦|X|^{♮r}|Y|^{♮r};
(ii) d(X∪Y)=dX∪Y+(−1)^{j+k}X∪dY;
(iii) (X∪Y)+(Z∪Y)=(X+Z)∪Y; and
(iv) a(X∪Y)=(aX∪Y)=(X∪aY).

PROOF. These follow by using the isomorphism of differential forms and cochains Theorem 3.15 and then applying corresponding results for differential forms and their wedge products.

Therefore the isomorphism Ψ of Theorem 3.15 is one on graded algebras.

Continuity of Vec(P).

LEMMA 3.20. Suppose P is a polyhedral chain and ω is a bounded, measurable differential form. If ω(p)=ω₀ for a fixed covector ω₀ and for all p, then
∫_{P}ω=w₀·Vec(P).

PROOF. This follows from the definition of the Riemann integral.

THEOREM 3.21. If P is a polyhedral k-chain and r≧1 then
M(Vec(P))≦|P|^{♮r}.
If spt(P)⊂B_{ε}(p) for some p ε [symbol] ⁿ and ε>0 then
|P|^{♮1}≦M(Vec(P))+εM(P).

PROOF. Set α=Vec(P) and let η₀ be a covector such that |η₀|₀=1, and η₀·α=M(α). Define the k-form η by η(p,β):=η₀(β). Since η is constant it follows that ∥η∥ᵣ=0 for all r>0 and ∥dη∥ᵣ=0 for all r≧0. Hence |η|ᵣ=|η|₀=|η₀|=1. By Lemma 3.20 and Theorem 3.5 it follows that
M(Vec(P))=η₀·Vec(P)=∫_{P}η≦|η|ᵣ|P|^{♮r}=|P|^{♮r}.

For the second inequality we use Corollary 3.17. It suffices to show that

$$\frac{\vert {\int }_{P} ω \vert}{{\vert ω \vert}_{1}}$$

is less than or equal the right hand side for any 1-form ω of class B¹. Given such w define the k-form ω₀(q,β):=ω(p,β) for all q. By Lemma 3.20

$$\vert {\int }_{P} ω \vert \leq \vert {\int }_{P} {ω}_{0} \vert + \vert {\int }_{P} ω - {ω}_{0} \vert \leq \vert ω ( p ) \cdot Vec ( P ) \vert + {sup}_{q ∈ spt P} \vert ω ( p ) - ω ( q ) \vert M ( P ) \leq {‖ ω ‖}_{0} M ( Vec ( P ) ) + ɛ {‖ ω ‖}_{1} M ( P ) \leq {\vert ω \vert}_{1} ( M ( Vec ( P ) ) + ɛ M ( P ) )$$

If A=lim_{i→∞}Pᵢ in the r natural norm then {Pᵢ} forms a Cauchy sequence in the r-natural norm. By Theorem 3.21 {Vec(Pᵢ)} forms a Cauchy sequence in the mass norm on Λₖ( [symbol] ⁿ). Define
Vec(A):=limVec(Pᵢ).
This is independent of the choice of approximating Pᵢ, again by Theorem 3.21.

COROLLARY 3.22.
Vec: Nₖ^{r}→Λ^{k}( [symbol] ⁿ)
is linear and continuous.

COROLLARY 3.23. Suppose A is a chainlet of class N^{r} and ω is a differential form of class B^{r}. If ω(p)=ω₀ for a fixed covector ω₀ and for all p then
∫_{A}ω=ω₀·Vec(A).

PROOF. This is merely Lemma 3.20 if A is a polyhedral chain. Theorem 3.21 lets us take limits in the r-natural norm. If Pᵢ→A in Nₖ^{r} then by Corollary 3.22 Vec(Pᵢ)→Vec(A). Therefore

$${\int }_{A} ω = {lim}_{i \to ∞} {\int }_{{P}_{i}} ω = {lim}_{i \to ∞} {ω}_{0} \cdot Vec ( {P}_{i} ) = {ω}_{0} \cdot Vec ( A ) .$$

The supports of a cochain and of a chainlet. The support spt(X) of a cochain X is the set of points p such that for each ε>0 there is a cell σ⊂U_{ε}(p) such that X·σ≠0.

The support spt(A) of a chainlet A of class N^{r} is the set of points p such that for each ε>0 there is a cochain X of class N^{r} such that X·A≠0 and X·σ=0 for each σ supported outside U_{ε}(p). We prove that this coincides with the definition of the support of A if A is a polyhedral chain. Assume

$$A = {\sum }_{i = 1}^{m} {α}_{i} {σ}_{i}$$

is nonoverlapping and the aᵢ are nonzero. We must show that spt(A) is the union F of the spt(σᵢ) using this new definition. Since X·A=∫_{A}φ(X) it follows that spt(A)⊂F. Now suppose x ε F; say x ε σᵢ. Let ε>0. We find easily a smooth differential form ω supported in U_{ε}(p), ∫_{σ}ᵢω≠0, ∫_{σ}_{ⱼ} ω=0, j≠i. Let X be the cochain determined by ω via integration. Then X·A≠0 and X·σ=0 for each σ supported outside U_{ε}(p).!

PROPOSITION 3.24. If A is a chainlet of class N^{r} with spt(A)=∅ then A=0. If X is a cochain of class N^{r} with spt(X)=∅then X=0.

PROOF. By Corollary 3.17 suffices to show X·A=0 for any cochain X of class N^{r}. Each p ε spt(X) is in some neighborhood U(p) such that Y·A=0 for any Y of class N^{r} with φ(Y)=0 outside U(p). Choose a locally finite covering {Uᵢ, i≧1} of spt(X). Using a partition of unity {ηᵢ} subordinate to this covering we have
X=ΣηᵢX
and φ(ηᵢX)=ηᵢφ(X)=0 outside Uᵢ. Hence
X·A=Σ(ηᵢX·A)=0.

For the second part it suffices to show that X·σ=0 for all simplexes σ. Each p ε σ, is in some neighborhood U(p) such that X·τ=0 for all τ⊂U(p). We may find a subdivision Σσᵢ of σ such that each σᵢ is in some U(p). Therefore X·σ=ΣX·σᵢ=0.

Cochainlets. The elements of the dual space (Nₖ^{∞})′ to Nₖ^{∞} are called cochainlets. All the results on cochains of class Nₖ^{r} carry over to cochainlets by taking limits. Cochainlets are characterized as differential forms, each with a uniform bound on all the derivatives of its coefficient functions. These form a Banach space and a differential graded module, but not an algebra. For example e^{x} is a function in (N₀^{∞})′, but e^{x}·e^{x}=e^{2x} is not since its derivatives are not uniformly bounded. We contrast this with C^{∞} forms which are a differential graded algebra but not a Banach space. On the other hand, each (Nₖ^{r})′, 0≦r<∞, is both a Banach space and a differential graded algebra.

### Calculus on Fractals—Star Operator

k-elements. In this section we make precise the notion of an infinitesimal of calculus. Imagine taking an infinitely thin square card and cutting it into four pieces. Stack the pieces and repeat, taking a limit. What mathematical object do we obtain? The reader will recall Dirac monopoles which are closely related. We show the limit, which the author calls a k-element, exists as a well defined chainlet and thus may be acted upon by any chainlet operator. We emphasize that these operators have geometric definitions, as opposed to the weak definitions arising from duals of differential forms. Let p ε [symbol] ⁿ and a be a k-direction in [symbol] ⁿ. A unit k-element αₚ is defined as follows: For each l≧0, let Qₗ=Qₗ(p,α) be the weighted k-cube centered at p with k-direction α, edge 2^{-l} and coefficient 2^{kl}. Then M(Qₗ)=1 and Vec(Qₗ)=α. We show that {Qₗ} forms a Cauchy sequence in the 1-natural norm. Let j≧1 and estimate |Qₗ−Qₗ₊ⱼ|^{♮1}. Subdivide

Qₗ into 2^{kj} binary cubes Q_{l,i} and consider Qₗ₊ⱼ as 2^{kj} copies of

$$\frac{1}{{2}^{{k}_{j}}} {Q}_{ℓ + j} .$$

We form 1-difference k-cells of these subcubes of Qₗ−Qₗ₊ⱼ with translation distance ≦2^{-l}. Since the mass of each Qₗ is one, it follows that

$$\begin{matrix}{\vert {Q}_{ℓ} - {Q}_{ℓ + j} \vert}^{{♮}_{1}} = {\vert {\sum }_{i = 1}^{{2}^{{k}_{j}}} ( {Q}_{ℓ , i} - \frac{1}{{2}^{{k}_{j}}} {Q}_{ℓ + j} ) \vert}^{{♮}_{1}} \leq \\ {\sum }_{i = 1}^{{2}^{{k}_{j}}} {‖ {Q}_{ℓ , i} - \frac{1}{{2}^{{k}_{j}}} {Q}_{ℓ + j} ‖}_{1} \leq {2}^{- ℓ} .\end{matrix}$$

Thus Qₗ converges to a 1-natural chain denoted αₚ with |αₚ−Qₗ|^{♮1}≦2^{1-l}. If we let a be any simple k-vector with nonzero mass, the same process will produce a chainlet αₚ depending only on α and p, whose mass is the same as that of α and supported in p. We obtain
αₚ=lim Qₗ and |αₚ−Qₗ|^{♮1}≦2^{1-l}M(α). (2)

Since Vec(Qₗ)=α for all l, it follows from Corollary 3.22 that Vec(αₚ)=α. If ω is a form of class B¹ defined in a neighborhood of p then ∫_{α}_{ₚ}ω=ω(p;α) by Corollary 3.23.

PROPOSITION 4.1. For each nonzero simple k-vector α and p ε [symbol] ⁿ there exists a unique chainlet αₚ ε Nₖ¹ such that Vec(αₚ)=α, spt(αₚ)={p} and ∫_{α}ω=ω(p; α) for all forms ω of class Bₖ¹.

PROOF. Let αₚ=lim Qₗ be as in (2). It is unique by Corollary 3.16 since ∫_{α}_{ₚ}ω=ω(p;α) for all forms ω of class Bₖ¹. Since Vec(αₚ)=α we know αₚ≠0. Since sptQₗ⊂Bₚ(2^{-l}) then sptαₚ is either the empty set or the set {p}. By Proposition 3.24 sptA=∅ [symbol] A=0. Hence sptA={p}.

The next proposition tells us that the particular shapes of the approximating polyhedral chains to αₚ does not matter. There is nothing special about cubes.

PROPOSITION 4.2. Let {Pᵢ} be a sequence of polyhedral k-chains such that
M(Pᵢ)≦C, spt(Pᵢ)⊂B_{ε}_{ᵢ}(p), Vec(Pᵢ)→α
for some C>0 and εᵢ→0. Then Pᵢ→αₚ in the 1-natural norm.

PROOF. By (2) αₚ=lim Qᵢ with Vec(Qᵢ)=α. By Theorem 3.21 and Corollary 3.22
|Pᵢ−Qᵢ|^{♮1}≦M(Vec(Pᵢ)−Vec(Qᵢ))+εᵢM(Pᵢ−Qᵢ)→0.

THEOREM 4.3. Fix p ε [symbol] ⁿ. The operator
Vec: Nₖ^{r}→Λ^{k}( [symbol] ⁿ)
is one-one on chainlets supported in p.

PROOF. By Proposition 4.1 and Theorem 2.2 we only need to show that if A ε Nₖ^{r} which is supported in p and satisfies Vec(A)=0 then A=0. Let X be an r-natural cochain. Define X₀ by
φ(X₀)(q):=φ(X)(p) for all q.
By Corollary 3.23
X·A=X₀·A=φ(X)(p)·Vec(A)=0
implying A=0.

A k-element chain

$$\dot{P} = {\sum }_{i = 1}^{m} {{b}_{i} ( {α}_{p} )}_{i}$$

is a chain of k-elements (αₚ)ᵢ with coefficients bᵢ in G. (Note that both the k-vector α and point p may vary with i.) Denote the vector space of k-element chains in [symbol] ⁿ by εₖ. The next theorem is a quantization of chainlets including, for example, fractals, soap films, light cones and manifolds.

THEOREM 4.4 (Density of element chains). The space of k-element chains εₖ is dense in Nₖ^{r}.

PROOF. Let R be a unit k-cube in [symbol] ⁿ centered at p with k-direction α. For each j≧1 subdivide R into 2^{kj} binary cubes R_{j,i} with midpoint p_{j,i} and edge 2^{-j}. Since R_{j,i}=2^{-jk}Qⱼ(p_{j,i}, α) it follows that

$$\begin{matrix}{\vert {R}_{j , i} - {2}^{- j k} {α}_{{p}_{j , i}} \vert}^{{1}_{}} \leq {2}^{- j k} {\vert {Q}_{j} ( {p}_{j , i} , α ) - {α}_{{p}_{j , i}} , \vert}^{{1}_{}} \leq \\ {2}^{- j k} {2}^{- j + 1} \\ = {2}^{- j + 1} M ( {R}_{j , i} )\end{matrix} .$$

Let

$${\dot{P}}_{j} = {\sum }_{i = 1}^{m} {2}^{- j k} {α}_{{p}_{j , i}} .$$

Then
|R−\dot{P}ⱼ|^{♮1}≦2^{-j+1}ΣM(R_{j,i})=2^{-j+1}M(R)=2^{-j+}1.

This demonstrates that

$${\dot{P}}_{j} = {->}^{{1}_{}} R .$$

This readily extends to any cube with edge ε.

Use the Whitney decomposition to subdivide a k-cell τ into binary k-cubes. For each j≧1 consider the finite sum of these cubes with edge ≧2^{-j}. Subdivide each of these cubes into subcubes Qⱼᵢ with edge 2^{-j} obtaining ΣᵢQⱼᵢ→τ in the mass norm as j→∞. Let α=Vec(τ) and pⱼᵢ the midpoint of Qⱼᵢ. Then

$${\vert τ - {\sum }_{i} {α}_{pji} \vert}^{{1}_{}} \leq {\vert τ - {\sum }_{i} {Q}_{ji} \vert}^{{1}_{}} + {\sum }_{i} {\vert {Q}_{ji} - {α}_{{p}_{ji}} \vert}^{{1}_{}} .$$

We have seen that the first term of the right hand side tends to zero as j→∞. By (2) the second is bounded by ΣᵢM(Qⱼᵢ)2^{-j+1}≦M(τ)2^{-j+1}→0. It follows that τ is approximated by elementary k-chains in the 1-natural norm. Thus elementary k-chains are dense in Pₖ. The result follows since polyhedral chains are dense in chainlets.

Multiplication of a smooth chainlet by a function. Let αₚ be a k-element and f a smooth function defined in a neighborhood of p. Define
fαₚ:=f(p)αₚ.
Extend to element chains \dot{P}=Σaᵢ(αₚ)ᵢ by
f\dot{P}:=Σaᵢf(αₚ)ᵢ.
It follows immediately from the definitions that ∫_{fα}_{ₚ}ω=∫_{α}_{ₚ}fω. Therefore
∫_{f\dot{P}}ω=∫_{\dot{P}}fω.

THEOREM 4.5. Let \dot{P} be a k-element chain and f a smooth function defined in a neighborhood of \dot{P}. Then
|f\dot{P}|^{♮r}≦2^{r}|f|ᵣ|\dot{P}|^{♮r}.

PROOF. By the chain rule and the Fundamental Integral Inequality of chainlet geometry,
|∫_{f\dot{P}}ω|=|∫_{\dot{P}}fω|≦|\dot{P}|^{♮r}|fω|ᵣ≦|\dot{P}|^{♮r}2^{r}|f|ᵣ|ω|ᵣ.
By 3.17

$${\vert f \dot{P} \vert}^{{r}_{} } = sup \frac{\vert {f}_{f \dot{P}} ω \vert}{{\vert ω \vert}_{r}} \leq {2}^{r} {\vert f \vert}_{r} {\vert \dot{P} \vert}^{{r}_{}} .$$

If A=lim Pᵢ is a chainlet and f a function define
fA:=lim fPᵢ.

Geometric star operator. Recall the Hodge star operator * of differential forms ω. We next define a geometric star operator on chainlets. If α is a simple k-vector in [symbol] ⁿ then *αis defined to be the simple (n−k)-vector with (n−k)-direction orthogonal to the k-direction of α, with complementary orientation and with M(α)=M(*α). The operator * extends to k-element chains \dot{P} by linearity. It follows immediately that *ω(P;*ω)=ω(p;α). (Indeed, we prefer to define *ω in this way, as dual to the geometric *.) Hence ∫\dot{P}ω=∫_{*\dot{P}}*ω. According to Theorem 3.17 |*\dot{P}|^{♮r}=|\dot{P}|^{♮r}. We may therefore define *A for any chainlet A of class N^{r} as follows: By Theorem 4.4 there exists k-element chains {\dot{P}ⱼ} such that A=lim_{j→∞}\dot{P}ⱼ in the r-natural norm. Since {\dot{P}ⱼ} forms a Cauchy sequence we know {*\dot{P}ⱼ} also forms a Cauchy sequence. Its limit in the r-natural norm is denoted *A. This definition is independent of the choice of the sequence {\dot{P}ᵢ}.

THEOREM 4.6 (Star theorem). *: Nₖ^{r}→Nₙ₋ₖ^{r} is a norm-preserving linear operator that is adjoint to the Hodge star operator on forms. It satisfies **=(−1)^{k(n-k)}I and
∫_{*A}ω=(−1)^{k(n-k)}∫_{A}*ω
for all A ε Nₖ^{r} and all (n−k)-forms ω of class B^{r}, r≧1, defined in a neighborhood of spt(A).

This result was first announced in [H4] and will appear in [10]

PROOF. We first prove this for k-elements αₚ, Since αₚ is a 1-natural chainlet we may integrate ω over it. Hence
∫_{α}_{ₚ}ω=ω(p;α)=*ω(p;*α)=∫_{*α}_{ₚ}*ω.
It follows by linearity that ∫_{\dot{P}}=*w for any elementary k-chain \dot{P}. Let A be a chainlet of class N^{r}. It follows from Theorem 4.4 that A is approximated by elementary k-chains A=lim_{j→∞}\dot{P}ⱼ in the r-natural norm. We may apply continuity of the integral (Theorem 3.5) to deduce
∫_{A}ω=∫_{*A}*ω

The Hodge star operator on forms satisfies **ω=(−1)^{k(n-k)}ω. It follows that
∫_{A}*ω=∫_{*A}**ω=(−1)^{k(n-k)}∫_{*A}ω.

Geometric coboundary of a chainlet. Define the geometric coboundary operator
⋄:Nₖ^{r}→Nₖ₊₁^{r+1}
by
⋄:=*∂*
Since ∂²=0 and **±I it follows that ⋄²=0.

The following theorem follows immediately from properties of boundary ∂ and star *. Let δ:=(−1)^{nk+n+1}*d* denote the coboundary operator on differential forms.

THEOREM 4.7 (Coboundary operator theorem). ⋄: Nₖ^{r}→Nₖ₊₁^{r+1} is a nilpotent linear operator satisfying
(i) ∫_{⋄A}ω=(−1)ⁿ⁺¹∫_{A}δω for all ω defined in a neighborhood of spt(A);
(ii) *∂=(−1)^{n+k}^{²}⁺¹⋄*; and
(iii) |⋄A|^{♮r}≦|A|^{♮r-1} for all chainlets A.

Geometric interpretation of the coboundary of a chainlet. This has a geometric interpretation seen by taking approximations by polyhedral chains. For example, the coboundary of 0-chain Q₀ in [symbol] ² with unit 0-mass and supported in a single point {p} is the limit of 1-chains Pₖ.

The coboundary of a 1-dimensional unit cell Q₁ in [symbol] ³ is approximated by a “paddle wheel”, supported in a neighborhood of |σ|.

If Q₂ is a unit 2-dimensional square in [symbol] ³ then its coboundary ΔQ₂ is approximated by the sum of two weighted sums of oppositely oriented pairs of small 3-dimensional balls, one collection slightly above Q₂, like a mist, the other collection slightly below Q₂. A snake approaching the boundary of a lake knows when it has arrived. A bird approaching the coboundary of a lake knows when it has arrived.

Geometric Laplace operator. The geometric Laplace operator
Δ: Nₖ^{r}→Nₖ^{r+2}
is defined on chainlets by
Δ:=(∂+⋄)²=(∂⋄+⋄∂).

Let Λ denote the Laplace operator on differential forms.

THEOREM 4.8 (Laplace operator theorem). Suppose A ε Nₖ^{r} and ω ε Bₖ₊^{r+2} is defined in a neighborhood of spt(A). Then ΔA ε Nₖ^{r+2},
|ΔA|^{♮r+2}≦|A|^{♮r,}
and
∫_{ΔA}ω=(−1)ⁿ⁻¹∫_{A}Λω.

The geometric Laplace operator on chainlets requires at least the 2-natural norm. Multiple iterations of Δ require the r-natural norm for larger and larger r. For spectral analysis and applications to dynamical systems the normed linear space Nᵣ^{∞} with the operator
Δ: Nₖ^{∞}→Nₖ^{∞}
should prove useful.

A chainlet is harmonic if
ΔA=0.
It should be of considerable interest to study the spectrum of the geometric Laplace operator Δ on chainlets.*
*The geometric Laplace operator was originally defined by the author with the object of developing a geometric Hodge theory.

Geometric representation of differentiation of distributions. An r-distribution on [symbol] ¹ is a bounded linear functional on functions f ε B₀^{r}( [symbol] ¹) with compact support. Given a one-dimensional chainlet A of class N^{r} define the r-distribution θ_{A} by θ_{A}(f):=∫_{A}f(x)dx, for f ε B₀^{r}( [symbol] ¹).

THEOREM 4.9. θ_{A} is linear and injective. Differentiation in the sense of distributions corresponds geometrically to the operator *∂. That is,
θ_{*∂A}=(θ_{A})′.
†
†Since this paper was first submitted in 1999, the author has extended this result to currents. |9|

PROOF. Suppose θ_{A}=θ_{B}. Then ∫_{A}f(x)dx=∫_{B}f(x)dx for all functions f ε B₀^{r}. But all 1-forms ω ε B₁^{r} can be written ω=fdx. By Corollary 3.16 chainlets are determined by their integrals and thus A=B.

We next show that θ_{*∂A}=(θ_{A})′. Note that *(f(x)dx)=f(x). Thus

$$\begin{matrix}{θ}_{★ \partial A} ( f ) = {\int }_{★ \partial A} f ( x ) ⅆ x \\ = {\int }_{\partial A} f \\ = {\int }_{A} ⅆ f \\ = {\int }_{A} {f}^{′} ( x ) ⅆ x \\ = {θ}_{A} ( {f}^{′} ) \\ = {( {θ}_{A} )}^{′} ( f )\end{matrix} .$$

### Extensions of Theorems of Green and Gauss

Curl of a vector field over a chainlet. Let S denote a smooth, oriented surface with boundary in [symbol] ³ and F a smooth vector field defined in a neighborhood of S. The usual way to integrate the curl of a vector field F over S is to integrate the Euclidean dot product of curlF with the unit normal vector field of S obtaining ∫_{S} curlF·ndA. By the curl theorem this integral equals ∫_{∂S}F·dσ.

We translate this into the language of chainlets and differential forms.

Let w be the unique differential 1-form associated to F by way of the Euclidean dot product. The differential form version of curlF is *dω. The unit normal vector field of S can be represented as the chainlet *S. Thus the net curl of F over S takes the form ∫_{*S}*dω. By the Star theorem 4.6 and Stokes' theorem for chainlets 3.7 this integral equals ∫_{S}dω=∫_{∂S}ω. The vector version of the right hand integral is ∫_{∂S}F·ds. The following extension of Green's curl theorem to chainlets of arbitrary dimension and codimension follows immediately from Stokes' theorem and the Star theorem and is probably optimal.

THEOREM 4.10 (Generalized Green's curl theorem). Let A be a k-chainlet of class N^{r} and ω a differential (k−1)-form of class B^{r} defined in a neighborhood of spt(A). Then
∫_{*A}*dω=∫_{∂A}ω.

PROOF. This is a direct consequence of Theorems 3.7 and 4.6.

It is not necessary for tangent spaces to exist for A or ∂A for this theorem to hold.

Divergence of a vector field over a chainlet. The usual way to calculate divergence of a vector field F across a boundary of a smooth surface D in [symbol] ² is to integrate the dot product of F with the unit normal vector field of ∂D. According to Green's Theorem, this quantity equals the integral of the divergence of F over D. That is,
∫_{∂D}F·ndσ=∫_{D}divFdA.
Translating this into the language of differential forms and chainlets with an appropriate sign adjustment, we replace the unit normal vector field over ∂D with the chainlet *∂D and divF with the differential form d*ω. We next give an extension of the Divergence theorem to k-chainlets in n-space. As before, this follows immediately from Stokes' theorem and the Star theorem and is probably optimal.

THEOREM 4.11 (Generalized Gauss divergence theorem). Let A be a k-chainlet of class N^{r} and ω a differential (n−k+1)-form of class B^{r+1} defined in a neighborhood of spt(A) then
∫_{*∂A}ω=(−1)^{(k-1)(n-k-1)}∫_{A}d*ω

PROOF. This is a direct consequence of Theorems 3.7 and 4.6.

As before, tangent vectors need not be defined for the theorem to be valid and it holds in all dimensions and codimensions.

Manifolds. The diffeomorphic image φ_{*}C in Euclidean space [symbol] ⁿ of a k-cell C in [symbol] ⁿ supports a unique k-chainlet for which integrals of k-forms coincide. A simple proof to this uses the implicit function theorem. The image is locally the graph of a smooth function and all such graphs naturally support chainlets. Therefore every diffeomorphism φ: U→V of open sets in [symbol] ⁿ induces a linear map from chainlets in U to chainlets in V, commuting with the boundary and pushforward operators. If W is a coordinate domain in a smooth manifold M, it then makes sense to speak of chainlets in W, meaning the image of a chainlet in [symbol] ⁿ under a diffeomorphism from an open set in [symbol] ⁿ to W, for this is independent of the diffeomorphism. Now define a chainlet in M to mean a finite sum of chainlets in coordinate domains. More accurately, these are smoothly embedded chainlets. Immersed chainlets can also be defined. Thus to each smooth manifold corresponds a family of Banach spaces of chainlets, and to smooth maps there correspond linear maps of these spaces.

All this is done without fixing Riemannian metrics. Stokes theorem follows by using partitions of unity and the theorem for [symbol] ⁿ. With metrics, star, curl, divergence, etc. can be introduced.

Chainlets may also be defined on Lipschitz Riemannian manifolds.

In the definitions give above of the natural chainlet norms, replace cells σ⁰ with singular cells τ⁰=fσ⁰. Define M(τ⁰) to be k-dimensional Hausdorff measure of τ⁰. Replace vectors υ with smooth, divergence free vector fields υ defined in a neighborhood of sptτ and let T_{υ} denote the time one map of the flow of υ. Define
|υ|:=sup{|υ(p)|:pεsptv}.
Norms of differential forms are defined as before, replacing vectors with vector fields. The previous definitions and results carry through locally. Global results require the pushforward operator be defined for chainlets and a change of variables result. These are naturally established using k-elements and deduced for chainlets by taking limits.

If f: U⊂ [symbol] ⁿ→V⊂ [symbol] ⁿ is Lipschitz then Dfₚ is defined on a subset of full measure by Rademacher's theorem. Therefore, for a.e. p ε U,
f_{*}(αₚ):=Dfₚ^{k}(αₚ)
is well defined so that f*ω(p,αₚ)=ω(f(p), f_{*}αₚ). Passing to integrals, we have
∫_{f*α}_{ₚ}ω=∫_{α}_{ₚ}f*ω,
yielding

PROPOSITION 4.12.
∫_{f*\dot{P}}ω=∫_{\dot{P}}f*ω
for all element chains \dot{P}.

THEOREM 4.13. If f: U⊂ [symbol] ⁿ→V⊂ [symbol] ⁿ is a biLipschitz metric preserving mapping and ω is a form of class Bₖ^{r} then
|f*ω|ᵣ≦|f|_{Lip}^{k+r}|ω|ᵣ.

PROOF. Observe M(fσ)≦|f|_{Lip}^{k}M(σ) for any k-cell σ. Then

$$\frac{{\int }_{σ} {f}^{*} ω }{M ( σ )} = \frac{{\int }_{f σ} ω}{M ( σ )} \leq \frac{M ( f σ ) {‖ ω ‖}_{0}}{M ( σ )} \leq {\vert f \vert}_{Lip}^{k} {‖ ω ‖}_{0} .$$

Thus
∥f*ω∥₀≦|f|_{Lip}^{k}∥ω∥₀.
Since f is biLipschitz the pushforward f_{*}υ is well defined. Since f is metric preserving if υ is divergence free, so is f_{*}υ. Then

$$\begin{matrix}\frac{{\int }_{σ} {f}^{*} ω - {T}_{υ} {f}^{*} ω}{\vert υ \vert M ( σ )} = \frac{{\int }_{f σ} ω - {T}_{{f}_{*} υ} ω}{\vert υ \vert M ( σ )} \leq \\ \frac{M ( f σ ) {‖ ω - {T}_{{f}_{*} υ} ω ‖}_{0}}{\vert υ \vert M ( σ )} \leq \\ {\vert f \vert}_{Lip}^{k} \frac{{‖ ω - {T}_{{f}_{*} υ} ω ‖}_{0}}{\vert υ \vert} \leq \\ {\vert f \vert}_{Lip}^{k} {‖ ω ‖}_{1} \frac{\vert {f}_{*} υ \vert}{\vert υ \vert}\end{matrix} .$$

Hence
∥f*ω∥₁≦|f|_{Lip}^{k+1}∥ω∥₁.

By induction

$$\begin{matrix}\frac{{‖ {f}^{*} ω - {T}_{υ} {f}^{*} ω ‖}_{r - 1}}{\vert υ \vert} = \frac{{‖ {f}^{*} ( ω - {T}_{{f}_{*} υ} ω ) ‖}_{r - 1}}{\vert υ \vert} \leq {\vert f \vert}_{Lip}^{k + r - 1} \\ \frac{{‖ ω - {T}_{{f}_{*} υ} ω ‖}_{r - 1}}{\vert υ \vert}\end{matrix} .$$

It follows that
∥f*ω∥ᵣ≦|f|_{Lip}^{k+r}∥ω∥^{r}.
Finally, note that
∥df*ω∥ᵣ₋₁=∥f*dω∥ᵣ₋₁≦|f|_{Lip}^{k+r}∥dω∥ᵣ₋₁.
The result follows from Lemma 3.4.

PROPOSITION 4.14. Let f: U⊂ [symbol] ⁿ→ [symbol] ⁿ be a biLipschitz, metric preserving mapping and \dot{P} be a k-element chain. Then
|f_{*}\dot{P}|^{♮r}≦|f|_{Lip}^{k+r}|\dot{P}^{♮r}.

PROOF. By Theorems 3.5 and 4.13
|∫_{f*\dot{P}}ω|=|∫_{\dot{P}}f*ω|≦|f*ω|ᵣ|\dot{P}|^{♮r}≦|f|_{Lip}^{k+r}ω|ᵣ|\dot{P}|^{♮r}.
Hence

$${\vert {f}_{*} \dot{P} \vert}^{{r}_{}} = sup \frac{\vert {\int }_{{f}_{*} \dot{P}} ω \vert }{\vert ω \vert} \leq {\vert f \vert}_{Lip}^{k + r} {\vert \dot{P} \vert}^{{r}_{}}$$

Since element chains are dense in chainlets we may define

$${f}_{*} A := {lim}_{i -> ∞} {f}_{*} {\dot{P}}_{i}$$

where A=lim_{i→∞}\dot{P}ᵢ in the r-natural norm. We deduce

THEOREM 4.15 (Pushforward operator). Let f: U⊂M→M be a biLipschitz metric preserving mapping and A be a chainlet of class N^{r}. Then
|f_{*}A|^{♮r}≦|f|_{Lip}^{k+r}|A|^{♮r}.

We close this section with a concise and general change of variables formula.

THEOREM 4.16 (Change of variables). Let f: U⊂ [symbol] ⁿ→ [symbol] ⁿ be a biLipschitz metric preserving mapping, ω be a differential form of class B^{r} and A be a chainlet of class N^{r}. Then
∫_{f*A}ω=∫_{A}f*ω.

This follows by Proposition 4.12 and taking limits in the chainlet norm.

This permits much of chainlet geometry to be extended to Lipschitz Riemmanian manifolds.

Heat equation for chainlet domains. Uniqueness of solutions: Let A be a chainlet in [symbol] ⁿ. Let R=A×[0, b]. Then
∂R=∂A×[0,b]+(−1)ⁿA×b+(−1)ⁿ⁻¹A×0.
Consider the heat equation

$$Δ u = \sum \frac{{\partial }^{2} u}{\partial {x}_{i}^{2}} = \frac{\partial u}{\partial t} .$$

Suppose u vanishes on ∂A×[0, b] and on A×0. Now dt=0 on A×b since t=b. Hence
∫_{∂R}u*dudt=0.
Set
β=2u(*du)dt+(−1)ⁿ⁻¹u²dv
where dv=dx₁dx₂ . . . dxₙ. Since

$$du ⩓ (* du ) = {( grad u )}^{2} dv = \sum {( \frac{\partial u}{\partial {x}_{i}} )}^{2} dv$$

we have
dβ=2(grad u)²dvdt.
Therefore, by Stokes' theorem for chainlet domains
∫_{∂R}β=2∫_{R}(grad 1)²dvdt.

Hence
(−1)ⁿ⁻¹∫_{∂R}u²dv=2∫_{R}(grad u)²dvdt.
I.e.,
∫_{A×b}u²dv+2∫_{R}(grad u)²dvdt=0
and thus

$${( grad u )}^{2} = \sum {( \frac{\partial u}{\partial {x}_{i}} )}^{2} = 0 ,$$

implying

$$\frac{\partial u}{\partial {x}_{i}} = 0$$

on R. Hence u is identically 0 on R. We conclude that if two temperature distributions coincide initially at t=0 and always on ∂R then they must be the same at each point of R and for each t.

Magnetic field for a chainlet domain. (draft) (e.g., the Sierpinski gasket) A magnetic field B in absence of an electric field satisfies a Maxwell equation
curl(B)=(4/c)j,
where j is the current and c is the speed of light. How do we get the magnetic field B, when the current is known? Stokes theorem can give the answer: take a closed path C which bounds a chainlet surface S. The line integral of B along C is the flux of curl(B) through the surface. By the Maxwell equation, this is proportional to the flux of j through that surface.

Simple case of the Biot-Savard law. Assume j is contained in a wire of thickness r which we align on the z-axis. To measure the magnetic field at distance R>r from the wire, we take a curve C: r(t)=(Rcos(t), Rsin(t), 0) which bounds a disc S and measure
2πRB=CB·ds=Scurl(B)dS=4Sπ/cjdS=4πJ/c,
where J is the total current passing through the wire. The magnetic field satisfies B=2J/(cR).*
*In the second part of these notes the author will present a formulation of Maxwell's equations using k-elements and the star and boundary operators.

Green's formula for chainlets. In the following theorem, the forms ω and η satisfy Sobolev conditions, M is a smooth manifold with boundary. tω is the tangential component to ∂M; nη is the normal component.

THEOREM 4.17 (Green's formula). Let ωεW^{1,p}Ω^{k-1}(M) and ηεW^{1,q}Ω^{k}(M) be differential forms on M where

$$\frac{1}{p} + \frac{1}{q} = 1.$$

Then
<dω,η>=<ω,δη>+∫_{∂M}tωΛ*nη

In this section, we give a version of Green's formula that assumes smooth forms and chainlet domains.

THEOREM 4.18 (Chainlet Green's Formula). Let ωεBₖ₋₁^{r+1} and ηεBₖ^{r+1}. If A ε N^{r}(M) then
∫_{A}dωΛ*η−∫_{A}ωΛd*η=∫_{∂A}ωΛ*η

PROOF. This follows from Stokes' theorem for chainlets:
∫_{A}d(ωΛ*η)=∫_{∂A}ωΛ*η.
But
∫_{A}d(ωΛ*η)=∫_{A}dωΛ*η−∫_{A}ωΛd*η

Green's formula is often stated assuming Sobolev conditions on the form. In the second part of these lecture notes, we will give Sobolev W^{1,p} versions of the natural norms by weighting the difference norms with the constant p.

### CHAPTER 5

### Poincaré Duality

In this chapter we establish Poincaré duality at the level of chainlets and cochains. We begin by finding a chainlet representation Ch(ω) of a differential form ω which converts a contravariant form into a covariant chainlet. This means that we will be able to do such things as pushforward differential forms under smooth mapping and define their boundaries. We call these representatives of forms exterior chainlets. We have to exercise caution here. Operators closed in the chainlet spaces may not preserve subspaces of exterior chainlets. For example, the boundary of an exterior chainlet is not generally an exterior chainlet itself but is a chainlet of lower dimension. The pushforward of an exterior chainlet is not generally an exterior chainlet unless the pushforward mapping is a diffeomorphism. (See Theorem 4.16.)

This leads us to a definition of cap product and a formulation of Poincaré duality at the level of chainlets and cochainlets which passes to the classical duality for homology and cohomology classes.

### Exterior Chainlets

Inner products of k-elements. Suppose α is a k-element supported in a point p. Since α is a chainlet, the star operator applies. Moreover, *α is also a discrete (n−k)-cell determined by the mass of α and star of the k-direction of α. This leads to a natural definition of inner product of k-elements α and β, supported in the same point.
<α,β> vol:=αΛ*β.

LEMMA 5.1. <α,β> is an inner product.

PROOF. Bilinearity follows from linearity of star and bilinearity of wedge product. Symmetry follows by symmetry of starred wedge product αΛ*β=βΛ*α. By definition of star we know α*α=vol. Therefore for a unit k-vector α, <α,α> vol=vol implies <α,α>=1. If α=0 then <α,α> vol=0 implies <α,α>=0. <α,β> vol=αΛ*β=βΛ*α=<β,α> vol.

A differential k-form ω of class B^{r} determines a unique k-chainlet Ch(ω) of class N^{r}, called an exterior chainlet. We show below that
∫_{M}<η,ω> vol=∫_{Ch(ω)}η
for all k-forms η of class B^{r}. We construct Ch(ω) as a limit of polyhedral chains.

Chainlet representations of differential forms. Let ω be a differential k-form of class B¹ defined in an open set U⊂ [symbol] ⁿ, Assume U is bounded. At each p the form ω determines a unique k-element Vec(ω,p) via the inner product on k-element chains at a point. That is, by the Riesz representation theorem there exists a unique Vec(ω,p) such that
ω(p,α)=<Vec(ω(p)),α>
for all k-vectors α. Take a cube Q⊂U from the binary lattice and subdivide it into smaller binary cubes Q_{k,i} with midpoint p_{k,i} and edge 2^{-k}. Define

$${\dot{P}}_{k} = {\sum }_{i} M ( {Q}_{k , i} ) Vec ( ω ( {p}_{k , i} ) ) .$$

It is a straightforward exercise to show that \dot{P}ₖ forms a Cauchy sequence in the 1-natural norm. Denote the chainlet limit by Ch(ω,Q). Now use a Whitney decomposition to subdivide U into cubes U=∪ⱼ₌₁^{∞}W^{j}. Define

$$Ch ( ω ) \text{:} = {\sum }_{j = 1}^{∞} Ch ( ω , {Q}^{j} ) .$$

This converges in the 1-natural norm since the total mass of the non-overlapping binary cubes is bounded.

Remark. It is worth noting that a parallel attempt to show the discrete form \dot{ω}ₖ=ΣᵢM(Q_{k,i})ω(p_{k,i}) converges in the B^{r} norm will fail. The sequence is not Cauchy as long as the supports are finite. However, these important and useful forms arise naturally in chainlet geometry as the dual spaces to subspaces of element chains. Here is a place where chains and cochains are quite different.

THEOREM 5.2. Suppose η,ω are k-forms. Then
∫_{M}<η,ω>dV=∫_{Ch(ω)}η.

PROOF. It suffices to work with the discrete approximators to Ch(ω) in a cube Q for both integrals.

$$\begin{matrix}{\int }_{M ( {Q}_{k , i}^{j} ) Vec ( ω ( {p}_{k , i} ) )} η = {\sum }_{i} M ( {Q}_{k , i}^{j} ) η ( {p}_{k , i} ) \cdot Vec ( ω ( {p}_{k , i} ) ) \\ = {\sum }_{i} M ( {Q}_{k , i}^{j} ) < Vec ( η ( {p}_{k , i} ) ) , Vect ( ω ( {p}_{k , i} ) ) > \\ = {\sum }_{i} {\int }_{Vec ( {Q}_{k , i}^{j} )} < η , ω > ⅆ V .\end{matrix}$$

Hence

$$\begin{matrix}{\int }_{{Q}^{j}} < η , ω > ⅆ V = {lim}_{k \to ∞} {\int }_{{\sum }_{i} Vec ( {Q}_{k , i}^{j} )} < η , ω > ⅆ V \\ = {\int }_{Ch ( ω , {Q}^{j} )} η .\end{matrix}$$

Now take write U as a sum of cubes in the Whitney decomposition to obtain
∫_{U}<η,ω>dV=∫_{Ch(ω)}η.
Since the result holds in each coordinate chart, it is valid over a manifold M.

COROLLARY 5.3. Suppose M is compact and r≧1. Then there exists a constant C>0 such that
|Ch(ω)|^{♮r}≦C|ω|ᵣ.
for all k-forms w of class B^{r}.

PROOF. This reduces to the following estimate:
|∫_{M}<η,ω>dV|≦|M|^{♮r}|<η,ω>dVᵣ≦C|η|ᵣ|ω|ᵣ
where C=vol(M).

THEOREM 5.4. Ch: Bₖ^{r}(M)→Nₖ^{r}(M) is a one-one linear mapping of k-forms of class B^{r} into r-natural k-chains with dense image.

PROOF. The mapping ω [symbol] Ch(ω) is clearly one-one and linear. To show the image is dense, it suffices to show that for any cell σ and ε>0 there is an ω such that
|∫φ(X)·ω−X·σ|≦|X|^{♮r}ε
for any X of class N^{r}. This yields
|Ch(ω)−Υ|^{♮r}>ε.
Choose an (n−k)-cell Q′ through q₀ εσ orthogonal to σ. The simplexes σ(q)=T_{q-q0}σ with q ε Q′ form a cell Q. Choose Q′ so small that |σ(q)−σ|^{♮r}<ε/2, q ε Q′. Define β=Vec(σ)/M(Q)in Q and β=0 in [symbol] ⁿ−Q it follows that
|∫φ(X)·β−X·σ|=|∫_{Q′}X·(σ(q)−σ)|≦|X|^{♮r}ε/2.
Choose a smooth form α in [symbol] ⁿ so that ∫β−α<ε/2.

PROPOSITION 5.5. If ωand η are k-forms of class B^{r} then
∫_{Ch(ω)}η=(−1)^{k}∫_{Ch(η)}ω.

PROOF.
∫_{Ch(ω)}η=∫_{M}<η,ω>dV=(−1)^{k}∫_{M}<ω,η>dV=(−1)^{k}∫_{Ch(η)}ω.

The pushforward of an exterior chainlet is not generally an exterior chainlet, unless f is a diffeomorphism.

THEOREM 5.6. Suppose M is compact. Ch: Bₖ^{r}(M)→Nₖ^{r}(M) satisfies
(i)*Ch(ω)=Ch(*ω);
(ii) f_{*}Ch(ω)=Ch(f⁻¹*ω) if f: M→N is a diffeomorphism;
(iii) ∂Ch(ω)=Ch(⋄(ω);
(iv) δCh(ω)=Ch(∂ω);
(v) ΔCh(o)=Ch(□ω).

PROOF. (i) follows directly from the definitions of * and Ch. (ii) Since M=f_{*}⁻¹N we have

$$\begin{matrix}{\int }_{Ch ( {f}^{- 1} * ω )} η = {\int }_{{f}_{*}^{- 1} N} < η , {f}^{- 1} * ω > ⅆ V \\ = {\int }_{M} < f * η , ω > ⅆ V \\ = {\int }_{Ch ( ω )} f * η \\ = {\int }_{f * Ch ( ω )} η .\end{matrix}$$

We give a proof to (v). The remaining (i) and (iii) are similar.

$$\begin{matrix}{\int }_{Ch ( •ω )} η = \int < η , •ω > ⅆ V \\ = \int < •η , ω > ⅆ V \\ = {\int }_{Ch ( ω )} •η \\ = {\int }_{Δ Ch ( ω )} η .\end{matrix}$$

The result follows. O

CONJECTURE 5.6.1. A chainlet A of class N^{r} is harmonic iff A=Ch(ω) for some harmonic ω of class B^{r}.

### Cap Product

We have seen that k-vectors are in one-one correspondence with k-elements. A k-vector α is also a k-covector via the inner product. If we wish to consider α as a covector, we will denote it by \tilde{α}. If α is a k-element and β is a j-element, we can define several products. If j=k we have the scalar product
ã·β:=<α,β>.

LEMMA 5.7. *\tilde{α}·β=\tilde{α}·*β.

If j<k then \tilde{α}└β denotes the (k−j)-covector
(\tilde{α}└β)·γ:=<α,βΛγ>,
for all (k−j)-elements γ, and is called the interior product of \tilde{α} with β. This can be seen geometrically as the orthogonal complement of β in α, i.e., βΛυ=α and \tilde{υ}=\tilde{υ}=\tilde{α}└β.

If j<k then \tilde{α}∩β is the unique (k−j)-element given by the Riesz representation theorem
η·(\tilde{α}∩β):=<ηΛα,β>.
This is called the cap product of \tilde{α} with β. A geometrical definition can be given as the (k−j)-element υ orthogonal to a so that υΛα=β.

A differential (j+s)-form ω of class B^{r} and a j-cochain X of class N^{r} determine a product, also called cap product,
X∩Ch(ω):=Ch(η)
where η(p):=φ(X)(p)∩ω(p).

LEMMA 5.8.
∫_{X∩Ch(ω)}φ(Y)=∫_{M}(Y)Λφ(X),ω>dV.

PROOF. Defining η as above it follows that

$$\begin{matrix}{\int }_{X ⋂ Ch ( ω )} ϕ ( Y ) = {\int }_{Ch ( η )} ϕ ( Y ) \\ = {\int }_{M} < ϕ ( Y ) , η > ⅆ V \\ = {\int }_{M} < ϕ ( Y ) ⩓ ϕ ( X ) , ω > ⅆ V .\end{matrix}$$

LEMMA 5.9. Suppose X is a j-cochain and Y is a k-cochain of class N^{r} with j<k. Then
(Y∪X)·Ch(ω)=Y·(X∩Ch(ω)).

PROOF. It follows from the definition of cap product that
<φ(Y)(p),φ(X)(p)∩ω(p)>=<φ(Y)(p)Λφ(X)(p),ω(p)>.
Taking integrals we have
∫_{M}<φ(Y)(p),φ(X))(p)∩ω(p)>dV=∫_{M}<φY(p)ΛφX(p),ω(p)>dV

By Theorem 5.2 and Lemma 5.8 it follows that

$$\begin{matrix}( Y ⋃ X ) \cdot Ch ( ω ) = {\int }_{Ch ( ω )} ϕ ( Y ) ⩓ ϕ ( X ) \\ = {\int }_{M} < ϕ ( Y ) ⩓ ϕ ( X ) , ω > ⅆ V \\ = {\int }_{X ⋂ Ch ( ω )} ϕ ( Y ) \\ = Y \cdot ( X ⋂ Ch ( ω ) ) .\end{matrix}$$

LEMMA 5.10. Suppose X is a j-cochain and ω is a k-form, j<k. Then
|X∩Ch(ω)|^{♮r}≦C|X|^{♮r}|Ch(ω)|^{♮r}.

PROOF. Suppose Y is a (k−j)-cochain. Then by the Fundamental Integral Inequality of chainlet geometry

$$\begin{matrix}\vert Y \cdot ( X ⋂ Ch ( ω ) ) \vert = \vert ( Y ⋃ X ) \cdot Ch ( ω ) \vert \leq {\vert Y ⋃ X \vert}^{{♮}_{r}} {\vert Ch ( ω ) \vert}^{{♮}_{r}} \leq \\ C {\vert Y \vert}^{{♮}_{r}} {\vert X \vert}^{{♮}_{r}} {\vert Ch ( ω ) \vert}^{♮r} .\end{matrix}$$

It follows that
|X∩Ch(ω)|^{♮r}≦C|X|^{♮r}|Ch(ω)|^{♮r}.

Let A be a chainlet of class N^{r}. By 5.4 A=lim Ch(ωᵢ). Define
X∩A :=limX∩Ch(ωᵢ).

This limit exists as a consequence of Lemma 5.10 and yields

THEOREM 5.11. For each r≧1 there exists a constant C>0 such that if X is a p-cochain and A is a (p+q)-chainlet of class N^{r} then
|X∩A|^{♮r}≦C|X|^{♮r}|A|^{♮r}.

THEOREM 5.12. If X is a p-cochain Y is a q cochain and A is a (p+q)-chainlet of class N^{r} then
(i) (X∪Y)·A=X·(Y∩A).
(ii) X∩(Y∩A)=(X∪Y)∩A;
(iii) ∂(X∩A)=(−1)^{p+1}dX∩A+X∩∂A;
(iv) I⁰∩A=A; I⁰·(X∩A)=X·A where I⁰ denotes the unit 0-form I⁰(p)≡1.
(v) f_{*}(f*X∩A)=X∩f_{*}A.

PROOF. (i) First approximate A with exterior chainlets A=lim Ch(ωᵢ). Then apply Lemma 5.9 and Theorem 5.11.

(ii) By (i) if Z is a cochain of class N^{r} then

$$\begin{matrix}Z \cdot ( X ⋂ ( Y ⋂ A ) ) = ( Z ⋃ X ) \cdot ( Y ⋂ A ) \\ = ( ( Z ⋃ X ) ⋃ Y ) \cdot A \\ = ( Z ⋃ ( X ⋃ Y ) ) \cdot A \\ = Z \cdot ( ( X ⋃ Y ) ⋂ A ) .\end{matrix}$$

It follows that X∩(Y∩A)=(X∪Y)∪A.

(iii) By (i) and Leibnitz' rule for cochains

$$\begin{matrix}Y \cdot ( \partial ( X ⋂ A ) ) = dY \cdot ( X ⋂ A ) \\ = ( dY ⋃ X ) \cdot A \\ = ( d ( Y ⋃ X ) + {( - 1 )}^{p + 1} ( Y ⋃ dX ) ) \cdot A \\ = ( Y ⋃ X ) \cdot \partial A + {( - 1 )}^{p + 1} ( Y ⋃ dX ) \cdot A \\ = Y \cdot ( X ⋂ \partial A + {( - 1 )}^{p + 1} dX ⋂ A ) .\end{matrix}$$

(iv) Y·(I⁰∩A)=(Y∪I⁰)·A=Y·A; and I⁰·(X∩A)=(I⁰∪X)·A=X·A.

$$\begin{matrix}Y \cdot f * ( f * X ⋂ A ) = f * Y \cdot f * X ⋂ A \\ = ( f * Y ⋃ f * X ) \cdot A \\ = f * ( Y ⋃ X ) \cdot A \\ = Y ⋃ X \cdot f * A \\ = Y \cdot ( X ⋂ f * A )\end{matrix} \qquad ( v )$$

### Poincaré Duality of Chains and Cochains

An oriented compact n-manifold M corresponds to a unique n-chainlet A_{M}, in the sense that integrals of forms coincide ∫_{M}ω=∫_{A}_{_{M}}ω. The cap product determines a Poincaré duality homomorphism
PD:(Nₚ^{r})′→Nₙ₋ₚ^{r}
by
PD(X):=X∩A_{M}.

THEOREM 5.13. If ω is a k-form of class B^{r} then
φ(ω)∩M=Ch(*ω).

PROOF. Suppose η is a (n−k)-form of class B^{r}. By 5.8
∫_{φ(ω)∩M}η=∫_{M}<η,ω>dV=∫_{M}ηΛ*ω=∫_{Ch(*ω)}η.
It follows from 5.5 that
X·Ch(ω)=(−1)^{k}∫_{X∩M}ω.

As another consequence, we have
PD(X)=Ch(φ(*X)).

The Poincaré duality homomorphism is not an isomorphism, although its image is dense in the space of chainlets. Consider a 1-cell Q that is a straight line segment. From the isomorphism theorem we know that if ωεBₚ^{r,α} then
PD(Ψ(ω))(υ)=∫_{M}ωΛυ
for all υεBₙ₋ₚ^{r}. Therefore the inverse would have to an r-smooth differential form ω satisfying ∫_{Q}^{υ}=∫_{M}ωΛυ for all r-smooth υ. However, the only possibility would be a form defined only on A.

A cochain X is harmonic if □X=0. If X is a cocyle then it is harmonic if dδX=d*d*X=0. A chainlet A is harmonic if ΔA=0. If A is a cycle it is harmonic if ∂⋄A=∂*∂*A=0. This extends the previous definition of PD defined on cochains.

THEOREM 5.14.
PD:(Nₚ^{r})′→Nₙ₋ₚ^{r}
is a homomorphism satisfying
PD(dX)=(−1)^{p+1}∂PD(X)
PD(*X)=*PD(X)
PD(δX)=±⋄PD(X);

PD(H) is harmonic if H is harmonic and M is closed.

If X and Y are cocycles with X−Y=dZ then PD(X) and PD(Y) are cycles and PD(X)−PD(Y)=PD(dZ)=∂PD((−1)^{p+1}Z). It follows that PD passes to singular cohomology and homology classes. Since classic Poincaré duality is an isomorphism of singular cohomology and homology classes, then PD is also an isomorphism at this level since the definitions coincide.

This theorem also implies that PD preserves Hodge decompositions since coboundaries are sent to coboundaries, boundaries are sent to boundaries and harmonic chainlets are sent to harmonic chainlets. Let denote the dense subspace of chainlets of the form Ch(ω). We know that ε is closed under the operators of ∂ and *.

COROLLARY 5.15. If A ∈ε then there exist B, C, H ∈ε such that
A=∂B+⋄C+H
where H is a harmonic chainlet.

Observe that this result is not possible via either the sharp or flat topologies of Whitney where harmonic chains are not defined. Either the star operator or boundary operator is missing. (See Table 1 of the preface.) It should be of considerable interest to study the spectrum of the geometric Laplace operator A on chainlets. This is also important for the development of chainlet Hodge theory. The geometric Hodge and Laplace operators were originally defined by the author for the purpose of developing a geometric Hodge theory for chainlets. With the extension of chainlet geometry to Riemannian manifolds developed in these notes, and the isomorphism theorem of [9] between summable currents and chainlets extended to compact Riemannian manifolds M, a Hodge decomposition for chainlets is immediate.*
*The unpublished 1998 Berkeley thesis of J. Mitchell, initially drafted under the supervision of the author and completed with Morris Hirsch, attempted to do this, but not all tools were available at the time. In particular, chainlets were not defined on Riemannian manifolds and the isomorphism between currents and chainlets was not well understood [9].

THEOREM 5.16. If C is a chainlet in a compact Riemannian manifold M there exist unique chainlets ∂A, δB and H in M, where H is harmonic, such that
C=∂A+δB+H.

PROOF. (sketch) The chainlet C determines a unique summable current c via c(ω)=f_{C}ω. The current has a unique Hodge decomposition c=∂a+δb+h where a, b, h are currents of the appropriate dimension. Each is associated to a unique chainlet A, B, H. The operators are respected under the operations of * and d. The result follows.

This is all well and good, but we would like to see a Hodge de composition of chainlets for all Riemannian manifolds and constructed geometrically. We would also like to see methods for calculations and specific examples. There is much remaining to do. Some of this will be treated in more detail in the second part of these lecture notes.

### Inner Products

Since every Hilbert space is reflexive, we know that chainlet spaces are not Hilbert spaces. However, we can identify a dense subspace of chainlets for which there is an inner product defined.

Effective Hilbert spaces. The author calls a Banach space X with norm | | an effective Hilbert space if there exists a dense vector subspace Y⊂ X and an operator <, >: X×Y→ [symbol] such that
(i) <, >is an inner product on Y×Y;
(ii) \sqrt{<B,B>}=|B| for all B ε Y;
(iii) <u+v, w>=<u,w>+<v,w> for all u, v ε X, w ε Y. <w,u+v>=<w,u>+<w,v> for all w ε X, u, v ε Y;
(iv) <au,v>=a<u,v>=<u,av> for all u ε X, v ε Y, a ε

[symbol]

Wale show that the Banach space N^{∞} of chainlets is an effective Hilbert space and find subspaces Y and inner products that satisfy the conditions of the definition. First set Y=ε, the subspace of exterior chailnets of N^{∞} consisting of chainlets of the form X∩M where X ε N^{∞}′ is a cochain.

LEMMA 5.17. If M is compact,
|X∩MA|^{♮r}≦vol(M)|X|^{♮r}.

PROOF.
|X∩M|^{♮r}=|Ch(φ(x)|^{♮r}≦vol(M)|X|^{♮r}.

DEFINITION 5.17.1. Inner product on N×ε
<A,X∩M>:=|*X·A|.

PROPOSITION 5.18. <∂A, Ch(ω)>=(−1)^{k}<A, ⋄Ch(ω)>.

Define ∥E∥=<\sqrt{<E,E>}

THEOREM 5.19. ∥E∥˜|E|^{♮}.

Remark:
<Ch(α),Ch(β)>=<α,β>.

### CHAPTER 6

### Locally Compact Abelian Groups

### DRAFT

We recall that a topological group is locally compact if and only if the identity e of the group has a compact neighborhood. Let G by a locally compact abelian group. Translation Tᵥ through a vector v is replaced by translation through a group element g. That is, T_{g}(U)=U+g where U⊂G. (We write our group action as addition rather than the more standard multiplication simply to fit with our previous exposition. This is strictly notational.) For our norms to carry through, we assume k=0 so that cells are all O-dimensional.

The cells γ of G will be sufficiently regular elements of the σ-algebra A(G) generated by the compact subsets. It is remarkable that there exists an essentially unique natural measure, the Haar measure, that allows us to measure the elements of A(G). Haar measures are unique up to positive scale factors. More precisely, a right Haar measure μ on a locally compact group G is a countably additive measure defined on the Borel sets of G which is right invariant in the sense that μ(A+x)=μ(A) for x an element of G and A a Borel subset of G and also satisfies some regularity conditions. For x ε G, denote |x|=μ(x). (We distinguish single elements x ε G and elements of A(G) to fit with our previous exposition. Certainly x ε A(G).)

Examples of locally compact abelian groups.
[symbol] ⁿ with vector addition as group operation.
The circle group T. This is the group of complex complex numbers of modulus 1. T is isomorphic as a topological group to the quotient group [symbol] /

[symbol]

Haar measure allows to define the notion of integral for (complex-valued) Borel functions defined on the group. In particular, one may consider various L^{p} spaces associated to Haar measure. Specifically,
L_{μ}^{p}(G)={f:G → [symbol] :∫_{G}|f(x)|^{p}dμ(x)}.

The Banach space L¹(G) of all μ-integrable functions on G becomes a Banach algebra under the convolution xy(g)=∫x(h)y(h⁻¹g)dμ(h) for x,y ε L¹(G).

If G is a locally compact abelian group, a character of G is a continuous group homomorphism from G with values in the circle group T. It is well known that the set of all characters on G is itself a locally compact abelian group, called the dual group of G, denoted G^{Λ}. The group operation on G^{Λ} is given by pointwise multiplication of characters, the inverse of a character is its complex conjugate and the topology on the space of characters is that of uniform convergence on compact sets. This topology is not necessarily metrizable. However, if the group G is a locally compact abelian group, then the dual group is metrizable.

THEOREM 6.1. (G^{Λ})^{Λ} is canonically isomorphic to G.

The isomorphism is given by x [symbol] {χ [symbol] χ(x)}. We define a distribution to be an element of the dual space of G.

Our next goal is to extend the definitions of the natural norm to G and obtain a theory of distributions on G that does not require the notion of differentiation. (See [12] for a related result.)

For g ε G let T_{g} denote translation through g
T_{g}(A)=A+g.
Let γ⁰εA(G) and g₁, . . . , gᵣ εG. Define
γ¹=γ⁰−T_{g1}γ⁰
and
γ^{j+1}=γ^{j}−T_{g}_{ⱼ₊₁}γ^{j}.

Let

$${D}^{j} = {\sum }_{i = 1}^{m} {α}_{i} {γ}_{i}^{j}$$

with coefficients aᵢ ε [symbol] This is called a G-chain of order j. The vector space of all such G-chains D^{j} is denoted D^{j}. A G-chain D⁰ of order 0 is sometimes simply called a G-chain.

G-chain mass. Given γ^{j} generated by γ⁰ εG and g₁, . . . , gⱼ ε G, define M(γ⁰)=∥γ⁰∥₀=μ(γ⁰) and for j≧1,
∥γ^{j}∥ⱼ=μ(γ⁰)|g₁||g₂| . . . |gⱼ|.
For

$${D}^{j} = {\sum }_{i = 1}^{m} {α}_{i} {γ}_{i}^{j} ,$$

possibly overlapping, define

$${‖ {D}^{j} ‖}_{j} = {\sum }_{i = 1}^{m} \vert {α}_{i} \vert {‖ {γ}_{i}^{j} ‖}_{j} .$$

Natural G-norms. For r≧0 define the r-natural G-norm

$${\vert P \vert}^{{♮}_{r}} = inf \{ {\sum }_{j = 0}^{r} {‖ {D}^{j} ‖}_{j} \}$$

where the infimum is taken over all decompositions

$$P = {\sum }_{j = 0}^{r} {D}^{j}$$

where D^{j} ε D^{j}. It is clear | |^{♮r} is a semi-norm. We shortly prove it is a norm.

Define
∫_{γ}f:=∫_{G}χ_{γ}fdμ.

Suppose f: G→T. Define

$${‖ f ‖}_{0} \text{:} sup \{ \frac{\vert {\int }_{γ} f \vert}{μ ( γ )} \text{:} γ ∈ A ( G ) \} .$$

Inductively define

$${‖ f ‖}_{r} \text{:} = sup \{ \frac{{‖ f - {T}_{υ} f ‖}_{r - 1}}{\vert υ \vert} \} .$$

Define
|f|₀:=∥f∥₀
and for r≧1,
|f|ᵣ:=max{∥f∥ₒ, . . . ∥f∥ᵣ}.
We say that f is of class B^{r} if |f|ᵣ<∞. Let B_{G}^{r} denote the space of functions on G of class B^{r}.

Given a compact subset K⊂M, there exists a smooth function f_{K} which vanishes outside an—neighborhood of K and which is nonzero on K. If M is infinitely smooth, we can also find a function φ_{K}: M→ [symbol] which is nonzero on K and such that all the derivative of φ_{K} are uniformly bounded by a constant C.

THEOREM 6.2. Let P ε D⁰, r ε [symbol] +, and f ε B_{G}^{r} defined in a neighborhood of spt(P). Then
|∫_{P}f|≦|P|^{♮r}|f|ᵣ.

PROOF. We first prove |∫_{γ}_{^{j}}f≦∥γ^{j}∥ⱼ∥f∥ⱼ. By the definition of ∥f∥₀ we know
|∫_{γ}_{⁰}f|≦∥γ⁰∥₀∥f∥₀.

Apply induction to deduce

$$\begin{matrix}\vert {\int }_{{γ}^{j}} f \vert = \vert {\int }_{{γ}^{j - 1} - {T}_{{υ}_{j}} {γ}^{j - 1}} f \vert \\ = \vert {\int }_{{γ}^{j - 1}} f - {T}_{{υ}_{j}}^{*} f \vert \leq {‖ {γ}^{j - 1} ‖}_{j - 1} {‖ f - {T}_{{υ}_{j}}^{*} f ‖}_{j - 1} \leq \\ {‖ {γ}^{j - 1} ‖}_{j - 1} {‖ f ‖}_{j} \vert {υ}_{j} \vert \\ = {‖ {γ}^{j} ‖}_{j} {‖ f ‖}_{j}\end{matrix}$$

By linearity
|∫_{D}_{^{j}}f|≦∥D^{j}∥ⱼ∥f∥ⱼ
for all D^{j} ε P_{G}^{j}.

We again use induction to prove |∫_{P}f|≦|P|^{♮r}|f|ᵣ. As before, |∫_{P}f|≦|P|^{♮0}|f|₀. Assume the estimate holds for r−1.

Let ε>0. There exists

$$P = {\sum }_{j = 0}^{r} {D}^{j}$$

such that

$${\vert P \vert}^{r} > {\sum }_{j = 0}^{r} {‖ {D}^{j} ‖}_{j} -$$

ε. By induction

$$\vert {\int }_{P} f \vert \leq {\sum }_{j = 0}^{r} \vert {\int }_{{D}^{j}} f \vert \leq {\sum }_{j = 0}^{r} {‖ {D}^{j} ‖}_{j} {‖ f ‖}_{j} \leq ( {\sum }_{j = 0}^{r} {‖ {D}^{j} ‖}_{j} ) {\vert f \vert}_{r} \leq ( {\vert P \vert}^{{♮}_{r}} + ɛ ) {\vert f \vert}_{r} .$$

Since the inequality holds for all ε>0 the result follows.

COROLLARY 6.3. |P|^{♮r} is a norm on the space of G-chains Pₖ.

PROOF. Suppose P≠0 is a G-chain. There exists a function f such that ∫_{P}f≠0 and |f|ᵣ<∞. Then 0<|∫_{P}f≦|P|^{♮r}|f|ᵣ implies |P|^{♮r}>0.

The Banach space of G-chains Pₖ completed with the norm | |^{♮r} is denoted G^{r}. The elements of G^{r} are called G-chainlets of class N^{r}. We let G^{∞} be the direct limit of the G^{r}. Define |A|^{♮}=lim_{r→∞}|A|^{♮r}. This is a norm since |∫_{A}f|≦|A|^{♮}|f|_{∞} and there exists f such that ∫_{A}f>0 and |f|_{∞}<∞. The characterization of the Banach space is essentially the same as for chainlets, except there is no boundary operator.

THEOREM 6.4. The Banach space G^{∞} is the smallest Banach space containing X⁰ and which has Lipschitz bounded translation operators.

Since the space is reflexive, these G-chainlets correspond to distributions over G. We obtain a theory of distributions on G that does not require the notion of differentiation.

### CHAPTER 7

### Discrete Calculus

### DRAFT

In the Ravello lectures the author presented two discrete theories with different flavors and applications. The first is drafted below in this first part of the lecture notes. The second discrete theory will appear in the second part of the lecture notes, under preparation. In both, we relax the use of triangulations, tesselations, cubical subdivisions, or the like, and no longer require that k-elements be connected to one another. Domains are supported in countably many points. We replace connectivity with multiplicity.

The first theory uses discrete chains and assumes that we have at our disposal classically defined smooth differential forms. The second approach is a full discrete theory where both chains and cochains are supported in the same countable set of points and will be fully presented in the second part of these lecture notes. In the full discrete theory, cochains are “measuring sticks” that match chains perfectly. We characterize the cochains by what the author calls “discrete forms”. Indeed, we propose replacing the venerable “Whitney forms” with discrete forms because our class of discrete forms is closed under the operations of * and d. Furthermore, cochains are associative and graded commutative. The operators *, d and A work seamlessly with each other at the discrete level and converge to the smooth continuum.

Differential k-elements. We saw in Chapter 4 that k-elements embed in the chainlet space Nₖ^{l}. The subspace of k-element chains is denoted Vₖ⁰. Those supported in a set J are denoted Vₖ⁰(J). We shall see that there is a vast array of chainlets supported in a single point and much of calculus can be found locally by understanding these and their operators and products.

A k-element is a mass normalized version of a cell, shrunk to a point. Elements are reminiscent of Dirac monopoles, but they have direction, dimension, multiplicity and orientation. We next extend the notion of Dirac dipoles, working towards a Grassman algebra of differential elements.

Let \dot{σ}(p) be a k-element with k-direction a and supported at p. We define its geometric directional derivative. Choose a tangent vector v based at p. Consider the sequence of difference elements

\dot{Q}ᵢ=2ⁱ(\dot{σ}(p)−T_{υ/2}_{ⁱ}\dot{σ}(p)), i≧0.

This forms a Cauchy sequence in the 2-natural norm since
|\dot{Q}ᵢ=2−\dot{Q}ᵢ₊ⱼ|^{♮2}≦∥\dot{Q}ᵢ−\dot{Q}ᵢ₊ⱼ∥₂≦2⁻ⁱM(\dot{σ}(p)).
(See Corollary 3.12.)

Remark. In order to make the notion of mass of a k-chainlet precise, we need to establish lower semi-continuity of mass in the natural norms. This will be addressed in the second part of these lecture notes.

The author calls the limit of the \dot{Q}ᵢ a differential k-element of order 1 and denotes it by ∇_{υ}\dot{σ}(p). It follows immediately from the definition of the operator ∇_{υ} that
∫_{∇}_{_{υ\dot{σ}(p)}}ω=∫_{\dot{σ}(p)}∇_{υ}ω.
The definition of directional derivative extends linearly to k-element chains \dot{P}=Σaᵢ\dot{σ}ᵢyielding ∇_{υ}\dot{P}=Σaᵢ∇_{υ}\dot{σ}ᵢ. Hence

THEOREM 7.1. If ω is a differential form of class B² and \dot{P} is a k-element chain then
∫_{∇}_{_{υ}}_{\dot{P}}ω=∫_{\dot{P}}∇_{υ}ω
and
|∇_{υ}\dot{P}|^{♮2}≧|\dot{P}^{♮1}.

PROOF.

$${\vert {∇}_{υ} \dot{P} \vert}^{{♮}_{2}} = sup \frac{\vert {\int }_{{∇}_{υ} \dot{P}} ω \vert}{{\vert ω \vert}_{2} } \leq sup \frac{\vert {\int }_{\dot{P}} {∇}_{υ} ω \vert}{{\vert {∇}_{υ} ω \vert}_{1}} = {\vert \dot{P} \vert}^{{♮}_{1}} .$$

We may therefore define the directional derivatives of chainlets by taking limits of element chains P in the 1-natural norm:
∇_{υ}:Nₖ¹→Nₖ²
and deduce

THEOREM 7.2. If ω is a differential form of class B² and A is a chainlet of class N¹ then
∫_{A}∇_{υ}ω=∫_{∇}_{_{υ}}_{A}ω.

### Lie Derivatives of Element Chains

If X is a vector field and a is a field of k-vectors we obtain a Lie derivative of a in the direction X. Let fₜ be the flow of X. Fix x₀ and define

$${{ℒ}_{X} ( α )}_{{x}_{0}} \text{:} = {lim}_{t \to 0} \frac{{f}_{- t} * {α}_{{x}_{t}} - {α}_{{x}_{0}}}{t} .$$

If X is smooth then the limit exists.

We similarly define L_{X} on fields of differential k-elements or order s. The limit exists in the s-natural norm as a field of differential k-elements or order s.

LEMMA 7.3.
L_{X}∂=∂L_{X}

PROOF.

$${ℒ}_{X} \partial α = lim \frac{{f}_{- t} \partial {α}_{{x}_{t}} - \partial {α}_{{x}_{0}}}{t} = \partial lim \frac{{f}_{- t} {α}_{{x}_{t}} - {α}_{{x}_{0}}}{t} = \partial {ℒ}_{X} α .$$

Define
L_{X}ω(p;α):=ω(p;L_{X}α).

PROPOSITION 7.4. The above definition coincides with the standard definition of Lie derivative of a differential form. Furthermore,
dL_{X}=L_{X}d

PROOF.
dL_{X}ω(p;α)=L_{X}ω(p;∂α)=ω(p;L_{X}∂α)=ω(p;∂L_{X}α)=L_{X}dω(p;α).

### An Equivalent Discrete Norm

The notion of a difference k-cell of order i naturally extends to all k-chainlets. Let \dot{σ}ᵢ denote a difference k-element of order i. That is, there exists a k-element \dot{σ} and vectors υ₀, . . . , υᵢ such that \dot{σ}ᵢ=(Id−T_{υ}_{ᵢ}) ∘ . . . ∘(Id−T_{υ}₀)\dot{σ}₀. Let \dot{D}ⁱ=Σαⱼ\dot{σ}ⱼⁱ, denote a difference k-element chain of order i and |\dot{D}ⁱ|ᵢ=Σⱼ|αⱼ|∥\dot{σ}ⱼⁱ∥ᵢ. Denote the vector space of all such difference k-element chains of order i by \dot{D}ₖⁱ.

THEOREM 7.5. Let \dot{P} ε Vₖ⁰. Then

$${\vert \dot{P} \vert}^{{♮}_{r}} = inf \{ {\sum }_{i = 1}^{r} {‖ {\dot{D}}^{i} ‖}_{i} \text{:} \dot{P} = {\sum }_{i = 1}^{r} {\dot{D}}^{i} , {\dot{D}}^{i} ∈ {\dot{D}}_{k}^{i} \} .$$

PROOF. To establish ≦ this reduces to showing that ∥\dot{D}ⁱ∥^{♮r}≦∥\dot{D}ⁱ∥ᵢ. This follows from Corollary 3.12. For the other direction, we again use Corollary 3.12.
|\dot{P}^{♮r}=inf{Σ∥Dⁱ∥ᵢ+|C|^{♮r}:\dot{P}=ΣDⁱ+∂C}
where Dᵢ is a difference k-chainlet chain of order i and C is a (k+1)-chainlet of class N^{r-1}. Thus for ε>0, there exists \dot{P}=ΣDⁱ+∂C such that
|\dot{P}|^{♮r}>Σ∥Dⁱ∥ᵢ+|C|^{♮r-1}−ε/2.
We may assume that the rhs consists of difference element chains since the lhs is an element chain. Furthermore, C must be a difference element chain, C=Σ\dot{E}ᵢ. By induction
|C|^{♮r-1}≧Σ∥\dot{E}ⁱ∥ᵢ−ε/2.
(This is immediate for r=1.) Thus \dot{P}=Σ\dot{D}ⁱ+Σ\dot{E}ⁱ and
|\dot{P}|^{♮e}>Σ∥\dot{D}ⁱ∥ᵢ+Σ∥\dot{E}ⁱ∥ᵢ−ε.

We remark that one cannot omit the boundary term in the polyhedral definition of the natural norms and obtain an equivalent norm. Without it, we would not be able to prove that staircases converge to the diagonal. However, with elements, shape is no longer important. Discrete staircases do converge to discrete diagonals without a boundary term being used.

Higher order differential elements. Define differential k-elements of order s as the directional derivatives of differential k-elements of order s−1.

Boundaries of k-elements. The boundary operator
∂:Vₖ^{s}→Vₖ₋₁^{s+1}
sends a differential k-element chain of order s to a differential (k−1)-element chain of order (s+1). Since k-element chains are dense in chainlets of class N^{r}, r≧1, linear functionals on them correspond to differential forms of class B^{r}, as was the case for polyhedral chains. One may therefore build a discrete theory using k-element chains as approximators to domains. However, it turns out to be more efficient and concise to place differential k-element cells of order s on an equal, but graded, footing with k-element cells and not be limited to finding them by taking limits of chains of the latter. Let the vector space of k-element chains of order s be denoted by Vₖ^{s} and define
Vₖ:=Vₖ⁰⊕Vₖ¹⊕ . . . .

Pushforward of k-elements. The pushforward operator
f_{*}:Vₖ→Vₖ
sends k-cells of order s to k-cells of order s via the total derivative at the supporting point. It allows dynamical systems to be modeled as we may replace f by the time-t map of a flow fₜ. Each diffeomorphism fₜ becomes linear at a point and takes the form f_{t*}(p,α)=(f(p), f_{*}(α))

THEOREM 7.6.
f_{*}∂=∂f_{*.}

Example. (Dedicated to my Ravello friends) A vortex, such as a hurricane, is approximated by time parametrized k-element chains
Σf_{t*}(pᵢ,αₚ_{ᵢ})
where each f_{t*} is a linear rotation. This is related to the vortex models of Chorin, but the full calculus is established for our models, including the boundary operator, star operator and the divergence theorem.

Similar examples exist for arbitrary dynamical systems, including saddles, sinks, sources, chaotic horseshoes, and the like.

Operators on differential forms. At this point we summarize new definitions of operators on differential forms. The goal is to define as much as possible at a geometrical level and obtain operators on forms through duality.
f*ω(p;α)=ω(f(p); D^{k}fₚ(α))
*ω(p;α):=ω(p;α)
dω(p;α):=ω(p;∂α)
∇_{υ}ω(p;α):=ω(p;∇_{υ}α)
L_{X}ω(p;α):=ω(p;L_{X}(α)).

Integrals of forms over element chains. If \dot{P}=Σαⱼ\dot{σ}(pⱼ) is a k-element chain and w is a smooth differential k-form then the integral ∫_{\dot{P}}ω is merely Σαⱼω(pⱼ)(σ(pⱼ)). That is, we simply evaluate the form at each point in the support of \dot{P}.

Stokes' theorem for element chains and smooth forms may now be stated

THEOREM 7.7.
∫_{∂\dot{P}}ω=∫_{\dot{P}}dω.

The star operator extends directly to k-elements
*:Vₖ→Vₙ₋ₖ.
Thus we have the star theorem.
Discrete divergence and curl theorems follow.
∫_{∂*\dot{P}}ω=∫_{*\dot{P}}dω.
∫_{*∂\dot{P}}ω=∫_{\dot{P}}d*ω.

Cup product of higher order elements. Cup product α∪β is defined for pairs (α,β) of k-elements o of order s and j-elements β of order t, supported in the same point p. The product is a (k+j)-element of order s+t, also supported in p. We take the k-elements σ and τ which generate α and β, resp., along with the vectors v₁, . . . vₛ and w₁, . . . wₜ. The product σ∪τ is a well defined (k+j)-element. The collection of vectors v₁, . . . , vₛ, w₁, . . . , wₜ produces a differential (k+j)-element of order (s+t).

THEOREM 7.8.
∂(α∪β)=((∂α)∪β)+(α∪(∂β)).

*
*Sign correction needed.

This definition may be linearly extended to define A∪B where A and B are higher order element chainlets, supported in the same finite set of points J.

Cup product of chainlets. It is not possible to define cup product as a continuous operator
Nⱼ^{♮}×Nₖ^{♮}→Nⱼ₊ₖ^{♮}
that extends cup product of k-elements and coincides with cup product of differential forms. Cup product and Hodge star leads to an inner product but the space of L¹ functions, a subspace of chainlets, is not a Hilbert space. However, cup product is defined on pairs of chainlets where one element of the pair is contained in a dense subspace of chainlets, namely the exterior chainlets defined earlier.
Nₖ^{♮}×εⱼ^{♮}→Nⱼ₊ₖ^{♮.}

Cup product converges in the natural norm, to define A∪Ch(ω) where A is an arbitrary chainlet and Ch(ω) is an exterior chainlet. This extends the standard wedge product on forms Ch(η∇ω)=Ch(η)∪Ch(ω). This leads to an inner product
<A, Ch(ω)>=∫_{A∪Ch(ω)}dv.

We first define cup product for pairs of element chains and exterior chainlets and then prove continuity in the first variable.

Let Ch(ω) be the exterior j-chainlet associated to a differential j-form ω. In local coordinates, ω(p)=Σa^{H}(p)dx^{H}. The differential j-form dx^{H} at p determines a unique unit j-element Ch(e^{H}) supported in p satisfying dx^{H}(Ch(e^{H}))=1.

Define
Ch(ω)(p):=Σa^{H}(p)Ch(e^{H}).

LEMMA 7.9. Let p, q CE R. If w is smooth then
|Ch(ω)(p)−Ch(ω)(q)|^{♮}≦|p−q||ω|^{♮}.

Let \dot{σ} be a k-element supported in p. Cup product of k-vectors and j-vectors is defined for k-elements and j-cells supported in a point p, of course, since it is defined for all vector spaces. This can be used to define
\dot{σ}∪Ch(ω)(p).
If \dot{P}=Σaᵢ\dot{σ}ᵢ is a k-element define
\dot{P}∪Ch(ω)=Σaᵢ\dot{σ}ᵢ∪Ch(ω).

THEOREM 7.10.
|\dot{P}∪Ch(ω)|^{♮}≦|\dot{P}|^{♮}|ω|^{♮}.

PROOF. Suppose \dot{P} is a k-element and ε>0. There exists a decomposition \dot{P}=Σ\dot{D}ⁱ with
|\dot{P}|^{♮}>Σ∥\dot{D}ⁱ∥ᵢ−ε.

Then
|\dot{P}∪Ch(ω)|^{♮}≦Σ|aᵢ||\dot{D}ⁱ∪Ch(ω)|^{♮}.

This reduces to showing ∥\dot{D}ⁱ∪Ch(ω)∥ᵢ≦∥\dot{D}ⁱ∥ᵢ|ω|ᵢ

Now \dot{σ}ⁱ∪Ch(ω) can be written as the sum of two chainlets, the first is an i^{th} order dipole based on \dot{σ}∪Ch(ω) and vectors v₁, . . . , vᵢ. Its dipole norm is bounded by
∥\dot{σ}∪Ch(ω)∥₀|v₁| . . . |vᵢ|≦∥\dot{σ}∥₀|v₁| . . . |ᵢ||ω|₀=∥\dot{σ}ⁱ∥ᵢ|ω|₀.
The second term is bounded by

$$M ( σ ) ( \vert ω ( p ) - ω ( p + {υ}_{1} ) + ω ( p + {υ}_{1} + {υ}_{2} ) - ω ( p + {υ}_{2} ) \vert + ⋯ ) \leq M ( \dot{σ} ) \vert {υ}_{1} \vert \vert {υ}_{2} \vert ⋯ \vert {υ}_{i} \vert {\vert ω \vert}_{i} = {‖ {\dot{σ}}^{i} ‖}_{i} {\vert ω \vert}_{i} .$$

Hence
∥\dot{σ}ⁱ∪Ch(ω)∥ᵢ≦∥\dot{σ}ⁱ∥ᵢ|ω|ᵢ.

In the top dimensional case, k=n, the result follows since \dot{P}∪Ch(ω)=0. By induction,

$$\begin{matrix}\sum \vert {a}_{ i} \vert {\vert { \dot{D}}^{i} ⋃ Ch ( ω ) \vert}^{♮} \leq \sum \vert {a}_{i} \vert {‖ {\dot{D}}^{i} ⋃ Ch ( ω ) ‖}_{i} \\ \leq 2 {\vert ω \vert}^{♮} \sum \vert {a}_{i} \vert {‖ {\dot{D}}^{i} ‖}_{i} \\ \leq 2 {\vert ω \vert}^{♮} ( \sum \vert {a}_{i} \vert {‖ {\dot{D}}^{i} ‖}_{i} )\end{matrix}$$

Properties of cup product.

1. Associative

2. Bilinear
(A+B)∪Ch(ω)=(A∪Ch(ω))+(B∪Ch(ω)).
A∪(Ch(ω)+Ch(η))=(A∪Ch(ω))+(A∪Ch(η)).

3. Operators:
∂(A∪Ch(ω))=(∂A)∪Ch(ω)+(A∪∂Ch(ω)).

4.
*(A∪Ch(ω))=*A∪Ch(*ω)

5.
f_{*}(A∪Ch(ω))=f_{*A∪f}_{*}(Ch(ω))

6.
(X∩M)∪(Y∩M)=f_{M}φ(X)∪*φ(Y)=(X∪Y)∩M

7. anti commutative
A∪*B=(−1)^{k}B∪*A

8. A∪A=0 if A is simple.

THEOREM 7.11. If A is a k-chainlet of class N^{r} and w is a k-form of class B^{r} then
∫_{A}ω=∫_{A∪*Ch(ω)}dV.

COROLLARY 7.12. Assume M has no boundary. Then δω=0 [symbol] ∂Ch(ω)=0. Also, dω=0 [symbol] ⋄Ch(ω)=0. ω is harmonic [symbol] if Ch(ω) is harmonic.

PROOF. By the Leibnitz rule for wedge product if α is a p-form and β a q-form then, d(αΛβ)=(−1)^{p}αΛdβ+dαΛβ.

Assume δω=0, Then d*ω=0. Then
X·∂Ch(ω)=dX·Ch(ω)=∫dφ(X)Λ*ω=(−1)^{k+1}∫φ(X)Λd*ω=0.
Since this holds for all X we deduce ∂Ch(ω)=0. Similarly, δ(αΛβ)=*d*(αΛβ)=*d(*αΛ*β)=*(d*αΛ*β+*αΛd*β)=δαΛβ+αΛδβ. Note that ⋄M=0. Hence ∫_{M}δ(φ(X)Λ*ω)=0.

Assume dω=0. Then δ*ω=0. Let ω be a (k−1)-form and X a k-cochain. Then δ(φ(X)Λ*ω)=0. Then
X·⋄Ch(ω)=δX·Ch(ω)=∫δφ(X)Λ*ω=∫φ(X)Λδ*ω=0.
It follows that ∂Ch(ω)=0.

Conversely, suppose ∂Ch(ω)=0. Then
δω·P=ω·⋄P=∫_{⋄P∪*Ch(ω)}dV=∫_{P∪⋄*Ch(ω)}dV=0.
Here, we use δdV=0. Now suppose ⋄Ch(ω)=0. Then
dω·P=ω·∂P=∫_{∂P∪Ch(ω)}dV=∫_{P∪∂Ch(ω)}dV=0.

Here we use ∫_{∂(P∪Ch(ω))}dV=0.

THEOREM 7.13 (Cartan's magic formula for differential elements).
L_{X}(α)=(Ch(φ(X))∪∂α)+∂(Ch(φ(X))∪α).
Define i_{X}a :=Ch(φ(X))∪α. Then i_{X}w(p;α)=ω(p; i_{X}α).
COROLLARY 7.14 (Cartan's magic formula for forms).
L_{X}ω=d(i_{X}ω)+i_{X}dω.
PROOF. By Theorem 7.13

$$\begin{matrix}{ℒ}_{X} ω ( p ; α ) = ω ( {( p ; ℒ )}_{X} ( α ) ) \\ = ω ( p ; Ch ( ϕ ( X ) ) ⋃ \partial α ) + ω ( p ; \partial ( Ch ( ϕ ( X ) ) ⋃ α ) ) \\ = d ( {i}_{X} ω ) ( p ; α ) + {i}_{X} d ω ( p ; α ) .\end{matrix}$$

There is an orthonormal basis to k-element chains supported in a finite set of points J. An inner product can be defined on these chains leading to new numerical methods.

### BIBLIOGRAPHY

[1] J. A. F. Plateau, Statique Experimentale et Theorique des Diquides Soumis aux Seules Forces Moleculaires, Paris, Gauthier-Villars, 1873
[2] Whitney, Hassler, Geometric Integration Theory, 1959
[3] Whitney, Hassler, Moscow 1935: Topology Moving Toward America, Collected Papers, Vol 1, Birkhauser, 1992.
[4] Federer, Herbert, GEOMETRIC MEASURE THEORY, Springer-Verlag, New York, 1969
[5] Weyl, Herman, Philosophy of Mathematics and Natural Science, Princeton University Press, 1949
[6] Harrison, Jenny, Stokes' theorem on nonsmooth chains, Bulletin AMS, October 1993.
[7]-, Continuity of the Integral as a Function of the Domain, Journal of Geometric Analysis, 8 (1998), no. 5, 769-795
[8]-. Isomorphisms differential forms and cochains, Journal of Geometric Analysis, 8 (1998), no. 5, 797-807.
[9]-, Geometric realizations of currents and distributions, Proceedings of Fractals and Stochastics III, Friedrichsroda, German, 2004.
[10]-, Geometric Hodge star operator with applications to the theorems of Gauss and Green, to appear, Proc Cam Phil Soc.
[H4]-, Flux across nonsmooth boundaries and fractal Gauss/Green/Stokes theorems, J. Phys. A 32 (1999), no. 28, 5317-5327. 8, 5317-5327. Flux across nonsmooth boundaries and fractal Gauss/Green/Stokes theorems, J. Phys. A 32 (1999), no. 28, 5317-5327.
[11] Flanders, Harley, Differential forms with applications to the physical science, Dover.
[12] Feichtinger, Hans, Compactness in translation invariant Banach spaces of distributions and compact multipliers, J. Math. Anal. Appl. 102, 1984, 289327.

I claim:

1. A method for numerically representing an object for computer modeling of said object comprising approximating said object by a series of chainlets.
